(19) United States
(12) Patent Application Publication
(10) Pub. No.: US 2023/0356755 A1
(43) Pub. Date: Nov. 9, 2023

(54) INFORMATION PROCESSING DEVICE, INFORMATION PROCESSING SYSTEM, AND METHOD, AND PROGRAM

(71) Applicant: Sony Group Corporation, Tokyo (JP)

(72) Inventors: Yifu TANG, Tokyo (JP); Shinichiro TSUDA, Tokyo (JP)

(73) Assignee: Sony Group Corporation, Tokyo (JP)

(21) Appl. No.: 18/246,037

(22) PCT Filed: Aug. 6, 2021
(86) PCT No.: PCT/JP2021/029310

§ 371 Date: Mar. 21, 2023

(30) Foreign Application Priority Data
Sep. 28, 2020 (JP) 2020-162398

(51) Int. Cl. B60W 60/00

(52) U.S. Cl. CPC B60W 60/0059; B60W 2556/45; B60W 2552/53; B60W 2556/40; G01C 21/30

(57) ABSTRACT

A data collection unit that acquires observation information of a travel environment of a moving apparatus such as an automated driving vehicle, a driving assistance processing unit that generates control information based on data collected by the data collection unit and performs driving control, and a determination unit that compares the observation information acquired by the data collection unit with external information acquired from an external device via a communication unit and determines a matching degree. In a case where the determination unit determines that a matching degree between the observation information and the external information is low, the driving assistance processing unit outputs a downward shift control request of an automated driving level or a shift request to manual driving, and executes downward shift control processing of the automated driving level or shift processing to the manual driving on the basis of selection of the user.

### TECHNICAL FIELD

The present disclosure relates to an information processing device, an information processing system, a method, and a program. More specifically, the present disclosure relates to an information processing device, an information processing system, a method, and a program that enable safer automated driving or manual driving.

### BACKGROUND ART

Nowadays, technological development related to automated driving is being actively carried out.

Automated driving technology is technology that enables automated driving on a road by using various sensors such as position detection means provided in a vehicle (automobile), and is expected to spread rapidly in the future.

However, at present, automated driving is in the development stage, and it is thought that it takes time before 100% automated driving becomes possible. For a while, it is predicted that traveling is performed while switching between automated driving and manual driving by the operator (driver) as appropriate.

For example, on a straight road with a sufficient road width such as an expressway, the vehicle travels in the automated driving mode, but in a case where the vehicle leaves the expressway and stops at a desired position in a parking lot, or on a mountain road with a narrow road width, or the like, it is predicted that it will be necessary to switch the mode, such as switching to the manual driving mode and performing traveling by operation of the operator (driver).

While the vehicle is performing automated driving, the operator (driver) does not have to look forward that is the traveling direction of the vehicle, and can take free action such as napping, watching TV, reading a book, or sitting backwards and talking with a person in the back seat, for example.

Note that examples of conventional techniques disclosed for the automated driving technique include Patent Document 1 (Japanese Patent Application Laid-Open No. 2020-029238), Patent Document 2 (Japanese Patent Application Laid-Open No. 2019-018842), Patent Document 3 (Japanese Patent Application Laid-Open No. 2019-185246), and the like.

Patent Document 1 discloses a technique for changing a driving mode according to a traveling environment during traveling. Patent Document 2 discloses a configuration for detecting a design defect of an operator assistance system. Further, Patent Document 3 describes a response to a failure of an automated driving control device.

The Society of Automotive Engineers (SAE), which is an automotive technical committee in the United States, defines six automated driving levels from level 0 (manual driving) to level 5 (fully automated driving) as levels of automated driving.

Countries around the world including Japan have employed this SAE definition of automated driving levels.

For example, automobile manufacturers in various countries around the world often specify which level of automated driving of the automated driving levels 0 to 5 is possible for each vehicle.

Furthermore, also in traffic rules of each country, for example, measures are taken such as establishing a rule that allows automated driving at level 3 in a part of an expressway.

Currently, no automated driving vehicle that achieves Level 5 (fully automated driving) is traveling, but it is predicted that many such vehicles will travel in the future.

However, when a failure occurs in the automated driving control device, an accident caused by the failure may occur.

In order to prevent such an accident, it is necessary to quickly detect a failure or abnormality of the automated driving control device and take a reliable measure.

### CITATION LIST

### Patent Document

Patent Document 1: Japanese Patent Application Laid-Open No. 2020-029238
Patent Document 2: Japanese Patent Application Laid-Open No. 2019-018842
Patent Document 3: Japanese Patent Application Laid-Open No. 2019-185246

### SUMMARY OF THE INVENTION

### Problems to be Solved by the Invention

The present disclosure has been made in view of the above-described problems, for example, and an object thereof is to provide an information processing device, an information processing system, a method, and a program capable of quickly detecting a failure or abnormality of an automated driving control device and taking a reliable measure.

### Solutions to Problems

A first aspect of the present disclosure resides in an information processing device, including:
a data collection unit that acquires observation information of a travel environment of a moving apparatus;
a driving assistance processing unit that generates control information based on data collected by the data collection unit and performs driving control; and
a determination unit that compares the observation information acquired by the data collection unit with external information acquired from an external device via a communication unit and determines a matching degree, in which
in a case where the determination unit determines that a matching degree between the observation information and the external information is low, the driving assistance processing unit outputs a downward shift control request of an automated driving level or a shift request to manual driving.

Moreover, a second aspect of the present disclosure resides in an information processing system including a moving apparatus and an external device, in which
the moving apparatus includes
a data collection unit that acquires observation information of a travel environment of the moving apparatus,
a driving assistance processing unit that generates control information based on data collected by the data collection unit and performs driving control, and
a communication unit that communicates with the external device,
the external device
is configured to acquire observation information of a travel environment of the moving apparatus and transmit the acquired observation information to the moving apparatus as external information,
the moving apparatus
includes a determination unit that compares the observation information acquired by the data collection unit with external information acquired from the external device and determines a matching degree, and
in a case where the determination unit determines that a matching degree between the observation information and the external information is low, the driving assistance processing unit outputs a downward shift control request of an automated driving level or a shift request to manual driving.

Moreover, a third aspect of the present disclosure resides in an information processing method executed in an information processing device, the information processing method including:
a data collection step in which a data collection unit acquires observation information of a travel environment of a moving apparatus;
a driving assistance processing step in which a driving assistance processing unit generates control information based on data collected by the data collection unit and performs driving control; and
a determination step in which a determination unit compares the observation information acquired by the data collection unit with external information acquired from an external device via a communication unit and determines a matching degree, in which
in a case where the determination unit determines that a matching degree between the observation information and the external information is low, the driving assistance processing unit outputs a downward shift control request of an automated driving level or a shift request to manual driving.

Moreover, a fourth aspect of the present disclosure resides in an information processing method executed in an information processing system including a moving apparatus and an external device, the information processing method including:
a data collection step in which a data collection unit of the moving apparatus acquires observation information of a travel environment of the moving apparatus;
a driving assistance processing step in which the driving assistance processing unit of the moving apparatus generates control information based on data collected by the data collection unit and performs driving control, and
a step in which the external device
acquires observation information of a travel environment of the moving apparatus and transmits the acquired observation information to the moving apparatus as external information;
a determination step in which a determination unit of the moving apparatus compares the observation information acquired by the data collection unit with external information acquired from the external device and determines a matching degree, in which
in a case where, in the determination step, it is determined that a matching degree between the observation information and the external information is low, the driving assistance processing unit of the moving apparatus outputs a downward shift control request of an automated driving level or a shift request to manual driving.

Moreover, a fifth aspect of the present disclosure resides in a program for causing an information processing device to execute information processing causing:
a data collection unit to execute a data collection step of acquiring observation information of a travel environment of a moving apparatus;
a driving assistance processing unit to execute a driving assistance processing step of generating control information based on data collected by the data collection unit and performing driving control; and
a determination unit to execute a determination step of comparing the observation information acquired by the data collection unit with external information acquired from an external device via a communication unit and determining a matching degree, in which
in a case where the determination unit determines that a matching degree between the observation information and the external information is low, the driving assistance processing unit is further caused to output a downward shift control request of an automated driving level or a shift request to manual driving.

Note that a program of the present disclosure is a program that can be provided by, for example, a storage medium or a communication medium provided in a computer-readable format to an information processing device or a computer system that can execute various program codes.

By providing such a program in a computer-readable format, processing corresponding to the program is implemented on the information processing device or the computer system.

Other objects, features, and advantages of the present disclosure will become apparent from a more detailed description based on embodiments of the present disclosure described below and the accompanying drawings. Note that a system in the present description is a logical set configuration of a plurality of devices, and is not limited to one in which devices with respective configurations are in the same housing.

### Effects of the Invention

According to a configuration of one embodiment of the present disclosure, it is possible to achieve safe traveling by detecting an abnormality in automated driving early and performing downward shift control of an automated driving level or shifting to manual driving.

Specifically, for example, there are provided a data collection unit that acquires observation information of a travel environment of a moving apparatus such as an automated driving vehicle, a driving assistance processing unit that generates control information based on data collected by the data collection unit and performs driving control, and a determination unit that compares the observation information acquired by the data collection unit with external information acquired from an external device via a communication unit and determines a matching degree. In a case where the determination unit determines that a matching degree between the observation information and the external information is low, the driving assistance processing unit outputs a downward shift control request of an automated driving level or a shift request to manual driving, and executes downward shift control processing of the automated driving level or shift processing to the manual driving on the basis of selection of the user.

With this configuration, it is possible to achieve safe traveling by detecting an abnormality in the automated driving early and performing the downward shift control of the automated driving level or the shifting to the manual driving.

Note that effects described in the present description are merely examples and are not limited, and additional effects may be provided.

### BRIEF DESCRIPTION OF DRAWINGS

FIG. 1 is a diagram describing a configuration example of an information processing system of the present disclosure.

FIG. 2 is a diagram for describing an automated driving level.

FIG. 3 is a diagram for describing a local dynamic map (LDM).

FIG. 4 is a diagram describing a configuration example of an information processing system of the present disclosure.

FIG. 5 is a diagram describing a configuration example of an information processing device of the present disclosure.

FIG. 6 is a diagram describing a configuration example of a data collection unit in a control unit of the information processing device of the present disclosure.

FIG. 7 is a flowchart describing a sequence of processing executed by the information processing device of the present disclosure.

FIG. 8 is a diagram describing an example of display data output by the information processing device of the present disclosure.

FIG. 9 is a diagram describing an example of display data output by the information processing device of the present disclosure.

FIG. 10 is a diagram describing an example of display data output by the information processing device of the present disclosure.

FIG. 11 is a diagram illustrating a flowchart describing a sequence of processing executed by the information processing device of the present disclosure.

FIG. 12 is a diagram illustrating a flowchart describing a sequence of processing executed by the information processing device of the present disclosure.

FIG. 13 is a diagram illustrating a flowchart describing a sequence of processing executed by the information processing device of the present disclosure.

FIG. 14 is a diagram illustrating a flowchart describing a sequence of processing executed by the information processing device of the present disclosure.

FIG. 15 is a diagram illustrating a flowchart describing a sequence of processing executed by the information processing device of the present disclosure.

FIG. 16 is a diagram illustrating a flowchart describing a sequence of processing executed by the information processing device of the present disclosure.

FIG. 17 is a diagram illustrating a hardware configuration example of the information processing device of the present disclosure.

### MODE FOR CARRYING OUT THE INVENTION

Hereinafter, details of an information processing device, an information processing system, and a method, and a program of the present disclosure will be described with reference to the drawings. Note that the description will be made according to the following items.
1. Outline of configuration example and processing of information processing system of present disclosure
2. Configuration example of information processing device in moving apparatus of present disclosure
3. Basic sequence of processing executed by information processing device of present disclosure
4. Specific example of processing executed by information processing device of present disclosure
4-1. (Processing Example 1) Processing example in case where acquired information of data collection unit and external information acquired from external device are distance information between moving apparatus and dividing line (stop line, lane, or the like)
4-2. (Processing Example 2) Processing example of comparing map information acquired from storage unit by driving assistance processing unit with map information acquired from map information provision server as external device
4-3. (Processing Example 3) Processing example in case where acquired information of data collection unit and external information acquired from external device are inter-vehicle distance information
4-4. (Processing Example 4) Processing example of analyzing operation status of moving apparatus using acquired information of data collection unit and external information acquired from external device
4-5. (Processing Example 5) Processing example of analyzing road sign and road surface display using acquired information of data collection unit and external information acquired from external device
4-6. (Processing Example 6) Driving control processing example according to distance calculation result between moving apparatus and stop line based on acquired information of data collection unit
5. Hardware configuration example of information processing device of present disclosure
6. Summary of configuration of present disclosure

### 1. Outline of Configuration Example and Processing of Information Processing System of Present Disclosure

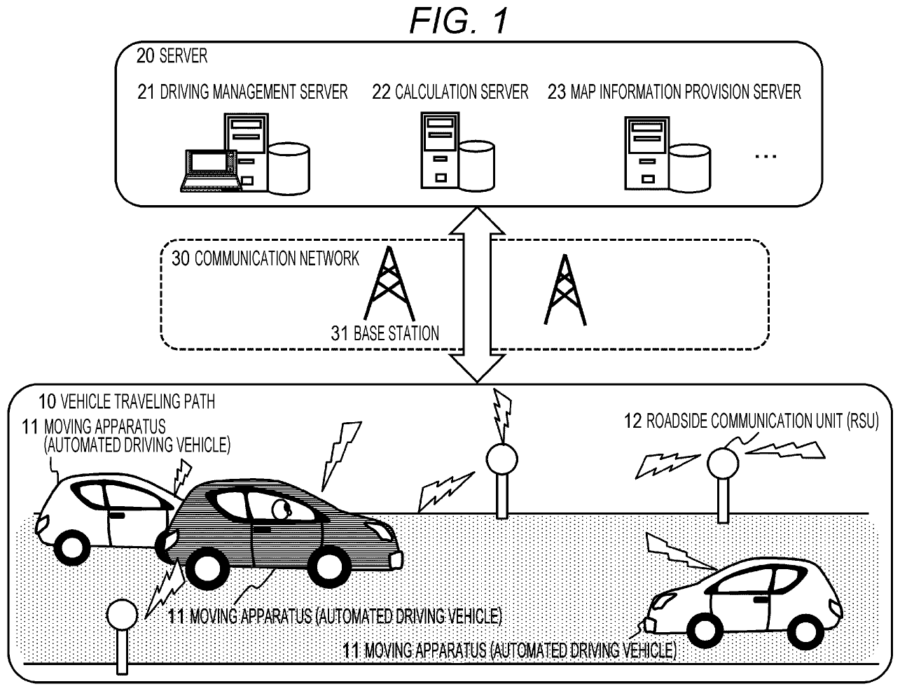

An outline of a configuration example and processing of the information processing system of the present disclosure will be described with reference to FIG. 1.

FIG. 1 is a diagram illustrating a configuration example of an information processing system of the present disclosure.

FIG. 1 illustrates a vehicle traveling road 10, a server 20, and a communication network 30.

The vehicle traveling road 10 is a road on which the moving apparatus (automated driving vehicle) 11 travels. Furthermore, a roadside communication unit (roadside unit (RSU)) 12 as a road infrastructure (road facility) is installed on the vehicle traveling road 10.

The moving apparatus (automated driving vehicle) 11 is an automated driving vehicle.

Note that, as described above, the Society of Automotive Engineers (SAE), which is an automotive technical committee in the United States, defines six automated driving levels from level 0 (manual driving) to level 5 (fully automated driving) as levels of automated driving. Many countries around the world including Japan have employed this SAE definition of automated driving levels.

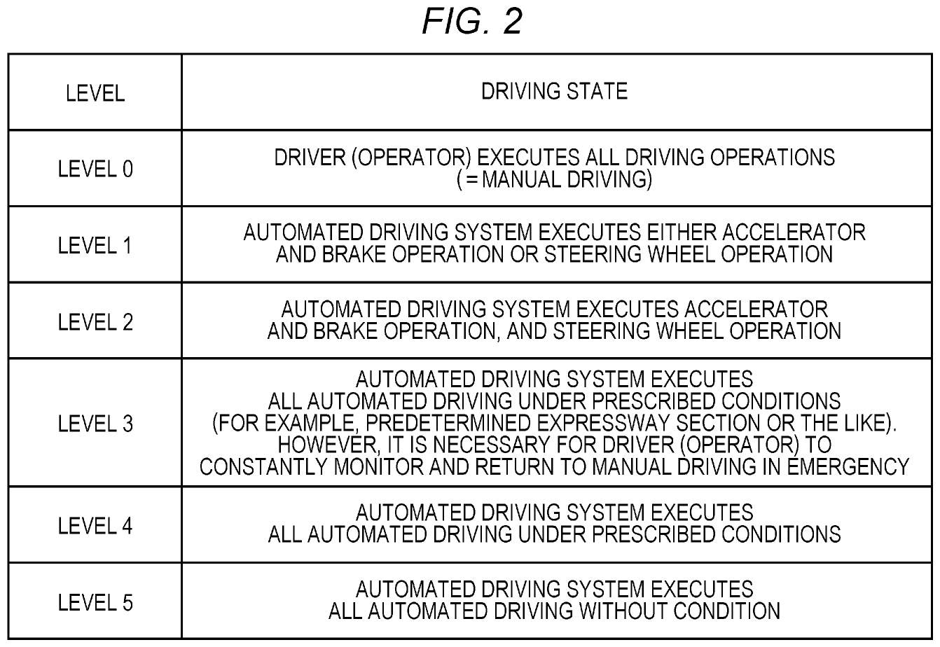

The SAE definition of automated driving levels will be described with reference to FIG. 2.

The SAE defines six levels of automated driving levels from level 0 (manual driving) to level 5 (fully automated driving) illustrated in FIG. 2 as levels of automated driving.

The definition (driving state) of each automated driving level is as follows.
Level 0=driver (operator) executes all driving operations (=manual driving)
Level 1=the automated driving system executes either an accelerator operation and a brake operation or a steering wheel operation
Level 2=the automated driving system executes an accelerator operation, a brake operation, and a steering wheel operation
Level 3=The automated driving system executes all automated driving under prescribed conditions (for example, a predetermined expressway section or the like). However, it is necessary for the driver (operator) to constantly monitor and return to manual driving in an emergency.
Level 4=The automated driving system executes all automated driving under prescribed conditions
Level 5=automated driving system executes all automated driving without condition

In the SAE, these six automated driving levels from level 0 (manual driving) to level 5 (fully automated driving) are defined.

Note that the prescribed condition at level 3 or level 4 is, for example, a condition for traveling at a specific place. Specifically, the driving condition is, for example, traveling on an expressway or in an area with relatively small traffic volume and good visibility such as an underpopulated area, in an area with a relatively simple travel environment such as a university premises or an airport facility, or the like.

The moving apparatus (automated driving vehicle) 11 illustrated in FIG. 1 is a vehicle capable of switching at least a plurality of levels of automated driving levels which are these SAE definition levels. For example, such a vehicle is a vehicle capable of switching between level 0 (manual driving) and level 2 (partially automated driving), a vehicle capable of switching between level 0 (manual driving) and level 4 (semi-automated driving), or a vehicle capable of switching between level 0 (manual driving) and level 5 (fully automated driving).

Returning to FIG. 1, the description of the configuration of the information processing system of the present disclosure will be continued.

The moving apparatus 11 can perform communication between moving apparatuses 11 and communication with the roadside communication unit (roadside unit (RSU)) 12.

Moreover, the moving apparatus 11 and the roadside communication unit (RSU) 12 can communicate with the server 20 via a communication network 30 such as a base station 31.

The server 20 includes a variety of different types of servers. For example, as illustrated in the drawing, a driving management server 21, a calculation server 22, a map information provision server 23, and the like are used.

The driving management server 21 acquires, from the moving apparatus 11, various data such as setting information of an automated driving level, data indicating a driving situation, or sensor detection information, and control information of a power system, a braking device, and a steering device mounted on the moving apparatus 11, and performs management related to movement, that is, traveling of the moving apparatus 11. Note that the management related to traveling is management or the like for automated driving control in a driving assistance processing unit in an information processing device mounted on the moving apparatus 11.

The calculation server 22 executes various arithmetic processing on the basis of an instruction from the driving management server 21. For example, the calculation server 22 executes machine learning (ML) or deep learning (DL) or the like using the data acquired from the moving apparatus 11 by the driving management server 21, and as a result, a learning model such as a neural network model is generated. For example, a learning model for each level of automated driving is generated and managed.

The map information provision server 23 is a server that provides map information to the moving apparatus 11. For example, the map information provision server 23 generates what is called a local dynamic map (LDM) that constantly updates traveling map information of the road on which the vehicle travels at high density, and provides the generated map to the moving apparatus 11.

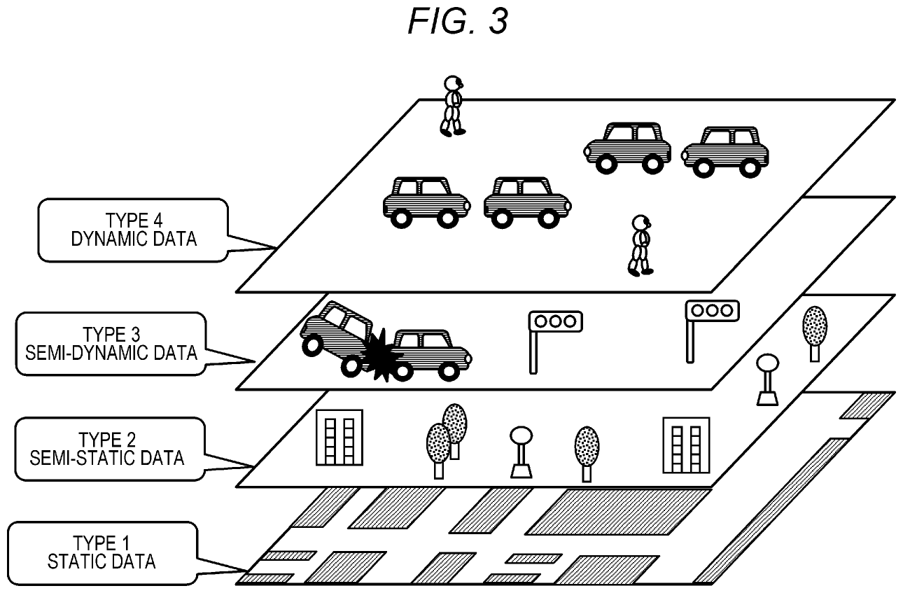

An outline of the local dynamic map (LDM) will be described with reference to FIG. 3. The local dynamic map (LDM) is one of pieces of information necessary when performing automated driving. Here, the LDM is, for example, high-definition three-dimensional map information.

As illustrated in FIG. 3, the LDM includes information groups of a plurality of types of hierarchical layers. That is, the LDM is configured by the following four types of information:
Type 1=Static data
Type 2=Semi-static data
Type 3=Semi-dynamic data
Type 4=Dynamic data

Type 1=The static data includes, for example, data such as map information generated on the basis of a Geospatial Information Authority of Japan map or the like updated in the medium to long term.

Type 2=The semi-static data includes, for example, data in which there is no large change in a short term but a change occurs in a long term, such as a structure such as a building, a tree, a sign, or the like.

Type 3=The quasi-dynamic data includes data that can change in a certain time unit, such as a signal, a traffic jam, or an accident.

Type 4=The dynamic data is traffic information of vehicles, people, and the like, and includes data that changes sequentially.

The map information provision server 23 transmits the local dynamic map (LDM) including these data to the moving apparatus 11. The moving apparatus 11 can analyze the LDM and use the LDM for automated driving control such as setting of a traveling route, control of a traveling speed and a lane, and the like.

Note that the map information provision server 23 continuously executes update processing of the local dynamic map (LDM) based on the latest information, and each moving apparatus 11 can acquire the latest information from the server and use the information at the time of using the LDM.

However, under the present circumstances, the section in which the automated driving vehicle can perform automated driving using the LDM information is a limited section such as a partial section of an expressway, and there are many sections in which manual driving by the driver is required. Furthermore, there is a case where the current LDM is not updated in a timely manner, and in such a case, there is a possibility that the map information of the old LDM is different from the current state. The present disclosure enables reliable handling even in such a case.

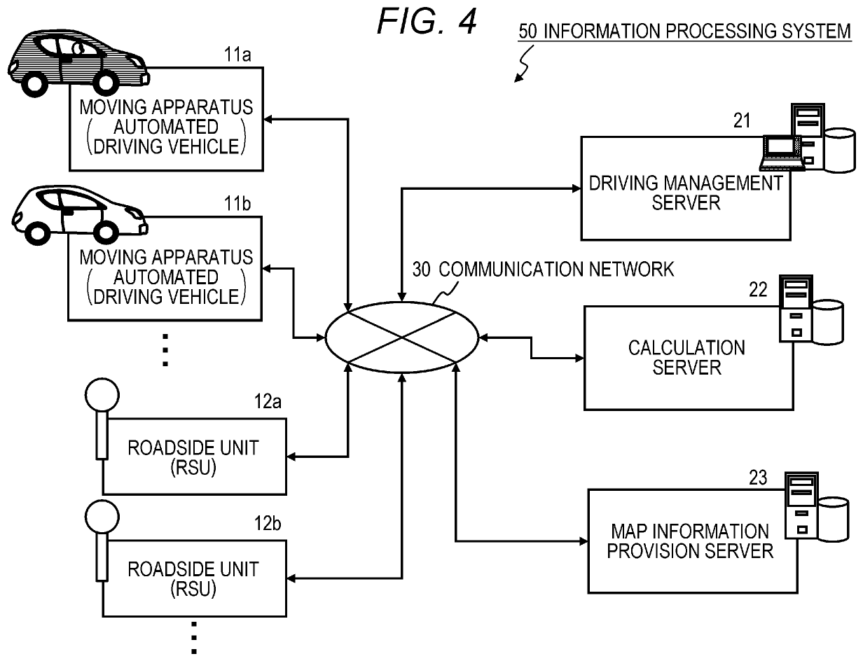

An overall configuration example and each component of the information processing system of the present disclosure will be described with reference to FIG. 4.

FIG. 4 is a diagram illustrating a configuration example of the information processing system 50 of the present disclosure.

As illustrated in FIG. 4, the information processing system 50 of the present disclosure includes moving apparatuses (automated driving vehicles) 11a and b, roadside communication units (RSU) (RSU) 12a and b, a driving management server 21, a calculation server 22, and a map information provision server 23. These devices can communicate with each other via the communication network 30.

Note that, although FIG. 4 illustrates two moving apparatuses (automated driving vehicles) 11a and b and two roadside communication units (RSU) (RSU) 12a and b, there can be many moving apparatuses (automated driving vehicles) 11 and roadside communication units (RSU) (RSU) 12. There can also be a plurality of servers 21 to 23, and there can also be various other servers.

The communication network 30 includes, for example, a plurality of base stations and the like.

The moving apparatus (automated driving vehicle) 11 is a vehicle capable of switching at least a plurality of levels of automated driving levels which are definition levels of SAEs as described above.

The moving apparatus 11 can perform communication between moving apparatuses 11 and communication with the roadside communication unit (roadside unit (RSU)) 12.

Note that communication between vehicles is referred to as V2V communication (vehicle-to-vehicle communication). Communication between a vehicle and an infrastructure facility such as a roadside communication unit (RSU) is called V2I communication (vehicle-to-infrastructure communication). Furthermore, these are collectively referred to as V2X communication. The V2X communication includes communication between a vehicle and a vehicle, communication between a vehicle and a pedestrian, communication between a vehicle and an infrastructure facility, communication between a vehicle and a server, and the like.

The moving apparatus 11 is a vehicle capable of the above-described V2X communication.

The moving apparatus 11 and the roadside communication unit (RSU) 12 can communicate with the server 20 via the communication network 30 such as the base station 31. For example, communication with the driving management server 21, the calculation server 22, the map information provision server 23, and the like illustrated in the drawing is performed.

As described above, the driving management server 21 acquires, from the moving apparatus 11, various data such as setting information of an automated driving level, data indicating a driving situation, or sensor detection information, and control information of a power system, a braking device, and a steering device mounted on the moving apparatus 11, and performs management related to movement, that is, traveling of the moving apparatus 11. Note that the management related to traveling is automated driving control management and the like in a driving assistance processing unit in an information processing device mounted on the moving apparatus 11.

The calculation server 22 executes various arithmetic processing on the basis of an instruction from the driving management server 21. For example, the calculation server 22 executes machine learning (ML) or deep learning (DL) or the like using the data acquired from the moving apparatus 11 by the driving management server 21, and as a result, a learning model such as a neural network model is generated. For example, a learning model for each level of automated driving is generated and managed.

The map information provision server 23 is a server that provides map information to the moving apparatus 11.

The map information provision server 23 generates a local dynamic map (LDM) having the configuration described with reference to FIG. 3, for example, and provides the generated map to the moving apparatus 11.

The moving apparatus 11 can analyze the LDM and use the LDM for automated driving control such as setting of a traveling route, control of a traveling speed and a lane, and the like.

### 2. Configuration Example of Information Processing Device in Moving Apparatus of Present Disclosure

Next, a configuration example of an information processing device mounted on the moving apparatus of the present disclosure will be described.

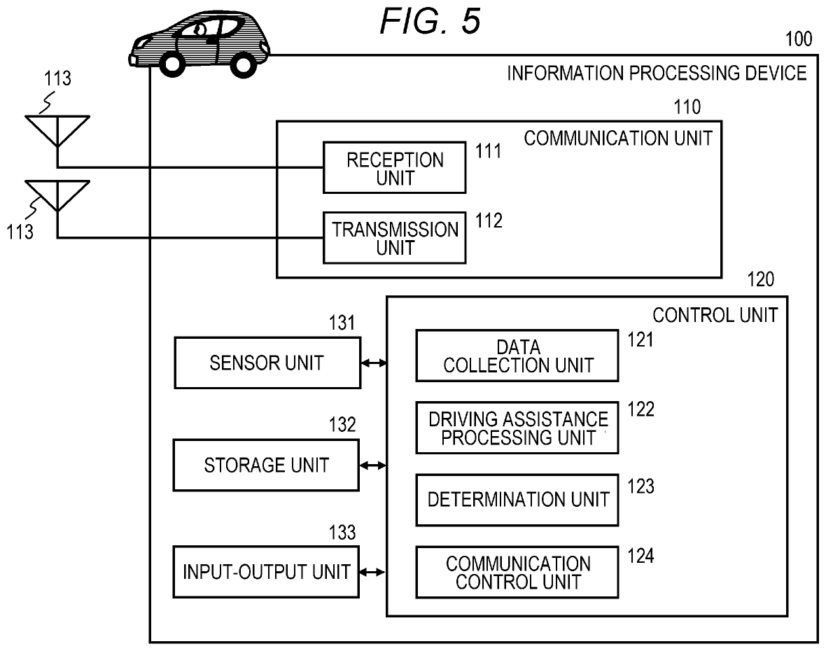

FIG. 5 is a diagram illustrating a configuration example of an information processing device 100 mounted on the moving apparatus 11 of the present disclosure.

As illustrated in FIG. 5, the information processing device 100 includes a communication unit 110, a control unit 120, a sensor unit 131, a storage unit 132, and an input-output unit 133.

The communication unit 110 includes a reception unit 111 and a transmission unit 112.

The control unit 120 includes a data collection unit 121, a driving assistance processing unit 122, a determination unit 123, and a communication control unit 124.

Note that the configuration illustrated in FIG. 5 is a partial configuration of the information processing device 100 mounted on the moving apparatus 11, and illustrates only main configurations used for the processing of the present disclosure.

The communication unit 110 communicates with an external device under the communication control unit 124 of the control unit 120. For example, communication with external devices such as another moving apparatus 11, the roadside communication unit (RSU) 12, the driving management server 21, the calculation server 22, and the map information provision server 23 illustrated in FIG. 4 is performed.

The communication unit 110 corresponds to one or a plurality of wireless communication access methods. For example, the communication unit 110 supports both the LTE method and the NR method. Furthermore, the communication unit 110 may be configured to support various communication methods such as W-CDMA and CDMA 2000 in addition to the LTE method and the NR method.

The communication unit 110 includes the reception unit 111, the transmission unit 112, and an antenna 113. Note that the communication unit 110 may include a plurality of reception units 111, a plurality of transmission units 112, and a plurality of antennas 113. For example, in a case where the communication unit 110 supports a plurality of wireless access methods, each unit of the communication unit 110 can be individually configured for each wireless access method. For example, the reception unit 111 and the transmission unit 112 may be individually configured by the LTE method and the NR method.

The sensor unit 131 includes a plurality of different sensors.

Sensor detection information of the sensor unit 131 is acquired by the data collection unit 121 of the control unit 120, and is stored in the driving assistance processing unit 122 or the accessible storage unit 132 of the driving assistance processing unit 122. Furthermore, the sensor detection information of the sensor unit 131 is provided to an external device, for example, the driving management server 21 via the communication unit 110 as necessary.

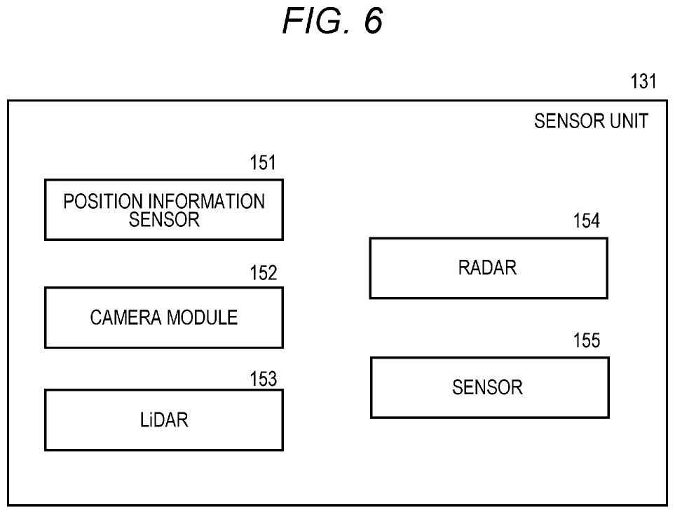

A detailed configuration example of the sensor unit 131 is illustrated in FIG. 6.

As illustrated in FIG. 6, the sensor unit 131 includes a position information sensor 151, a camera module (including an image sensor) 152, a Light Detection and Ranging or Laser Imaging Detection and Ranging (LiDAR) 153, a radar 154, a sensor 155, and the like.

The position information sensor 151 is, for example, a global navigation satellite system (GNSS) represented by a global positioning system (GPS).

In addition, it may be a sensor using a positioning technology using a signal transmitted and received via the communication unit 110 corresponding to the odometer, the long term evolution (LTE), the 4G, or the 5G cellular system.

The camera module 152 is equipped with a plurality of image sensors, and acquires image information of the outside of the moving apparatus (vehicle) and image information of the inside of the vehicle including the movement and expression of the driver.

The LiDAR 153 and the radar 154 detect various objects such as other vehicles and obstacles around the moving apparatus and acquire data necessary for measuring the distance to the detection object.

The sensor 115 includes, for example, an inertial measurement unit called an inertial measurement unit (IMU) that is a unit in which an acceleration sensor, a rotation angle acceleration sensor, a gyro sensor, a magnetic field sensor, an atmospheric pressure sensor, a temperature sensor, and the like are integrated.

As described above, acquired information of the sensor unit 131 is provided to the driving assistance processing unit 122 via the data collection unit 121 of the control unit 120, and is stored in the accessible storage unit 132 of the driving assistance processing unit 122. Furthermore, the acquired information of the sensor unit 131 is provided to an external device, for example, the driving management server 21 via the communication unit 110 as necessary.

The storage unit 132 is, for example, a storage device capable of reading and writing data, such as a DRAM, an SRAM, a flash memory, or a hard disk. The storage unit 132 functions as a storage unit of the information processing device 100.

The input-output unit 133 is an interface for exchanging information with a user such as a driver, for example. For example, the input-output unit 133 functions as an interface that can be operated by the driver, such as an operation key and a touch panel.

The input-output unit 133 may be configured as a display device such as a liquid crystal display or an organic electroluminescence (EL) display. In addition, the input-output unit 133 may be a sound device such as a speaker, a microphone, or a buzzer. In addition, the input-output unit 133 may be a lighting device such as a light emitting diode (LED) lamp. The input-output unit 133 functions as an input-output unit (input unit, output unit, operation unit, or notification unit) of the information processing device 100.

The control unit 120 is a controller that controls each unit of the information processing device 100. The control unit 120 includes, for example, a processor such as a CPU and an MPU, and a memory such as a RAM and a ROM. The processor of the control unit 120 executes various programs stored in the storage unit 132 using a memory such as a RAM as a work area, and executes various necessary processes in the information processing device 100.

Note that the control unit 120 may be achieved by an integrated circuit such as an ASIC or an FPGA. Any of the CPU, the MPU, the ASIC, and the FPGA can be regarded as a controller.

As illustrated in FIG. 5, the control unit 120 includes the data collection unit 121, the driving assistance processing unit 122, the determination unit 123, and the communication control unit 124.

Each block (the data collection unit 121 to the communication control unit 124) constituting the control unit 120 is a functional block indicating a function of the control unit 120. These functional blocks may be software blocks or hardware blocks.

For example, each of the functional blocks described above may be one software module achieved by software (including a microprogram) or one circuit block on a semiconductor chip (die). In addition, each functional block may be one processor or one integrated circuit. A configuration method of the functional block is arbitrary. Note that the control unit 120 may be configured by a functional unit different from the above-described functional block.

Note that the information processing device 100 illustrated in FIG. 5 is a device mounted in the moving apparatus 11, and for example, the driving assistance processing unit 122 of the control unit 120 controls each component of the vehicle such as an engine, an accelerator, a brake, a steering wheel (steering), and a transmission, and executes automated driving control.

The data collection unit 121 acquires the sensor detection information of the sensor unit 131. The sensor detection information collected by the data collection unit 121 is provided to the driving assistance processing unit 122 and stored in the accessible storage unit 132 of the driving assistance processing unit 122. Furthermore, the sensor detection information of the sensor unit 131 is provided to an external device, for example, the driving management server 21 via the communication unit 110 as necessary.

As described above, the driving assistance processing unit 122 controls each component of the vehicle such as the engine, the accelerator, the brake, the steering wheel (steering), and the transmission of the moving apparatus 11, and executes automated driving control.

The driving assistance processing unit 122 performs automated driving control by controlling a driving steering unit of the moving apparatus 11 on the basis of an output obtained by inputting data collected by the data collection unit 121 to artificial intelligence (AI), for example, machine learning or a neural network model generated by deep learning.

For example, automated driving control by advanced driver-assistance systems (ADAS) or autonomous driving (AD) is executed.

The driving assistance processing unit 122 performs, for example, processing of supplying control information such as acceleration, deceleration, and the like of the moving apparatus 11 to the power system, supplying control information such as deceleration, stop, and the like to the braking device, and supplying control information such as xx [cm] left, yy [cm] right, and the like to the steering device (steering), and the like.

Note that the neural network model (learning model) used for the automated driving control by the driving assistance processing unit 122 may be mounted in the driving assistance processing unit 122 in advance, or may be acquired from the external driving management server 21 or calculation server 22 via the base station 31, the roadside communication unit (RSU) 12, or the like, stored in the storage unit 132, and updated as appropriate.

In addition, the neural network model (learning model) used for the automated driving control by the driving assistance processing unit 122 may be one neural network model or may be configured by a plurality of neural network models. The plurality of neural network models may be a neural network model prepared for each sensor as what is called edge AI or a neural network model prepared for each control of the control unit 120.

The information processing device 100 attached to the moving apparatus 11 according to the present embodiment detects the presence or absence of an abnormality in automated driving or manual driving on the basis of information acquired via the data collection unit 121 or the communication unit 110 of the control unit 120. Moreover, in a case where an abnormality is detected, an appropriate response according to a situation of the detected abnormality is performed, and processing for maintaining safe driving is executed.

Hereinafter, this specific processing will be described.

### 3. Basic Sequence of Processing Executed by Information Processing Device of Present Disclosure

Next, a basic sequence of processing executed by the information processing device of the present disclosure will be described.

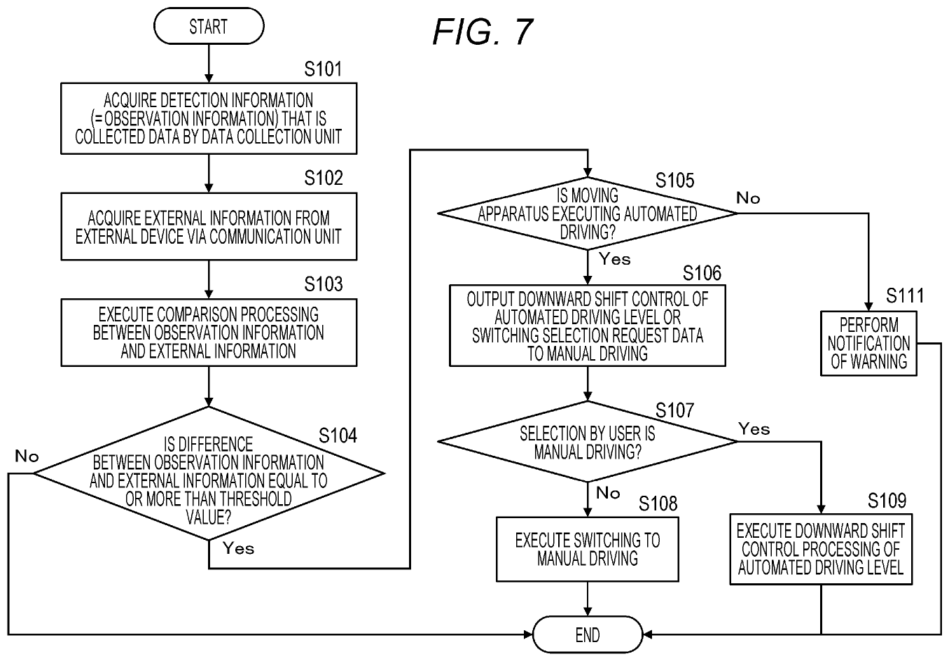

A basic sequence of processing executed by the information processing device 100 of the present disclosure described with reference to FIG. 5, that is, the information processing device 100 attached to the moving apparatus 11 will be described with reference to a flowchart illustrated in FIG. 7.

Note that processing according to the flow described below can be executed according to a program stored in the storage unit 132 of the information processing device 100, for example. For example, it is executed under the control of a data processing unit (control unit) including a CPU or the like having a program execution function.

Hereinafter, processing of each step of the flowchart illustrated in FIG. 7 will be sequentially described.

(Step S101)

First, in step S101, the control unit 120 of the information processing device 100 acquires collection data by the data collection unit 121, that is, sensor detection information (=observation information) acquired in the sensor unit 131.

This processing is executed by the data collection unit 121 and the driving assistance processing unit 122 in the control unit 120 of the information processing device 100.

The data collection unit 121 collects the sensor detection information of the sensor unit 131. As described above with reference to FIG. 6, the sensor unit 131 includes the position information sensor 151, the camera module 152, the LiDAR 153, the radar 154, and the sensor 155.

The data collection unit 121 acquires detection information of these various sensors of the sensor unit 131. The information acquired by the data collection unit 121 includes, for example, self-position information, a camera-captured image, object distance information, and the like.

The driving assistance processing unit 122 acquires these pieces of information (observation information) collected by the data collection unit 121. The driving assistance processing unit 122 generates control information necessary for automated driving on the basis of the observation information. For example, processing of calculating the inter-vehicle distance from the preceding vehicle on the basis of the camera-captured image and the object distance information collected by the data collection unit 121, calculating and controlling the optimum speed on the basis of the calculated inter-vehicle distance, and the like are performed.

First, in step S101, the driving assistance processing unit 122 acquires detection information (=observation information) collected by the data collection unit 121.

(Step S102)

Next, in step S102, the control unit 120 of the information processing device 100 acquires external information from the external device via the communication unit 110.

This processing is executed by the communication unit 110 of the information processing device 100 and the driving assistance processing unit 122 in the control unit 120.

The driving assistance processing unit 122 in the control unit 120 acquires the external information from the external device via the communication unit 110.

Note that the external device is, for example, another moving apparatus that travels in the vicinity of the host vehicle such as in front of and behind the host vehicle, a roadside communication unit which is a road infrastructure in the vicinity of the host vehicle, or an external server (driving management server, calculation server, map information provision server, or the like).

Furthermore, the external information acquired from the external device is, for example, environmental information such as inter-vehicle distance information, speed information, and map information measured by another moving apparatus, the roadside communication unit, or the external server.

In step S102, the driving assistance processing unit 122 in the control unit 120 acquires the external information from the external device via the communication unit 110.

(Step S103)

Next, in step S103, the driving assistance processing unit 122 in the control unit 120 executes comparison processing between the observation information acquired in step S101 and the external information acquired in step S102.

That is, the driving assistance processing unit 122 in the control unit 120 executes comparison processing between the following two pieces of information.
(a) The observation information input from the data collection unit 121 in step S101
(b) The external information acquired from the external device via the communication unit in step S102

Specifically, for example, comparison processing or the like is performed between the inter-vehicle distance information calculated from the observation information input from the data collection unit 121 in step S101, and the inter-vehicle distance information acquired from the external device via the communication unit in step S102.

(Step S104)

Next, in step S104, the determination unit 123 in the control unit 120 determines whether or not a difference between the observation information acquired in step S101 and the external information acquired in step S102 is equal to or more than a predetermined threshold value.

That is, the matching degree between the observation information acquired in step S101 and the external information acquired in step S102 is determined.

For example, it is assumed that the inter-vehicle distance information calculated from the observation information input from the data collection unit 121 in step S101 is 4.5 m, and the inter-vehicle distance information acquired from the external device via the communication unit in step S102 is 4.3 m.

The driving assistance processing unit 122 in the control unit 120 calculates these differences and compares them with the predetermined threshold value.

For example, it is assumed that
threshold value=0.1 m.

In this case, a difference between the inter-vehicle distance information=4.5 m calculated from the observation information input from the data collection unit 121 and the inter-vehicle distance information=4.3 m acquired from the external device is as follows.
Difference=4.5−4.3=0.2 m
0.2 m (difference)>0.1 m (threshold value)

In a case where it is determined in step S104 that the difference between the observation information acquired in step S101 and the external information acquired in step S102 is equal to or more than the predetermined threshold value, it is determined that the matching degree between the observation information and the external information is low, and the processing proceeds to step S105.

On the other hand, in step S104, in a case where it is determined that the difference between the observation information acquired in step S101 and the external information acquired in step S102 is less than the predetermined threshold value, the processing is ended.

In this case, it is determined that the observation information acquired from the data collection unit 121 substantially matches the information acquired from the outside, that is, the matching degree is high. Then, it is determined that the accuracy of the observation information in the data collection unit 121 is high and safe automated driving is possible, and the processing is ended without performing the processing of step S105 and subsequent steps.

On the other hand, in a case where the difference between the observation information acquired from the data collection unit 121 and the information acquired from the outside is large, it is determined that the accuracy of the observation information acquired by the data collection unit 121 is low and there is a possibility that safe automated driving cannot be performed, and the processing of step S105 and subsequent steps is performed.

(Step S105)

The processing of step S105 and subsequent steps is executed in a case where it is determined in step S104 that the difference between the observation information acquired from the data collection unit 121 and the external information acquired from the external device is equal to or more than the predetermined threshold value.

In this case, in step S105, the driving assistance processing unit 122 in the control unit 120 determines whether or not the moving apparatus is currently executing automated driving.

In a case where the moving apparatus is executing automated driving, the processing proceeds to step S106.

On the other hand, in a case where the moving apparatus is executing manual driving instead of automated driving, the processing proceeds to step S111.

(Step S106)

The processing of step S106 and subsequent steps is processing executed in a case where the moving apparatus is executing automated driving in step S105.

In a case where the moving apparatus is executing the automated driving, first, in step S106, the driving assistance processing unit 122 in the control unit 120 outputs the downward shift control of the automated driving level or switching selection request data to the manual driving.

For example, the downward shift control of the automated driving level or the switching selection request data to the manual driving is output to a display unit of the moving apparatus.

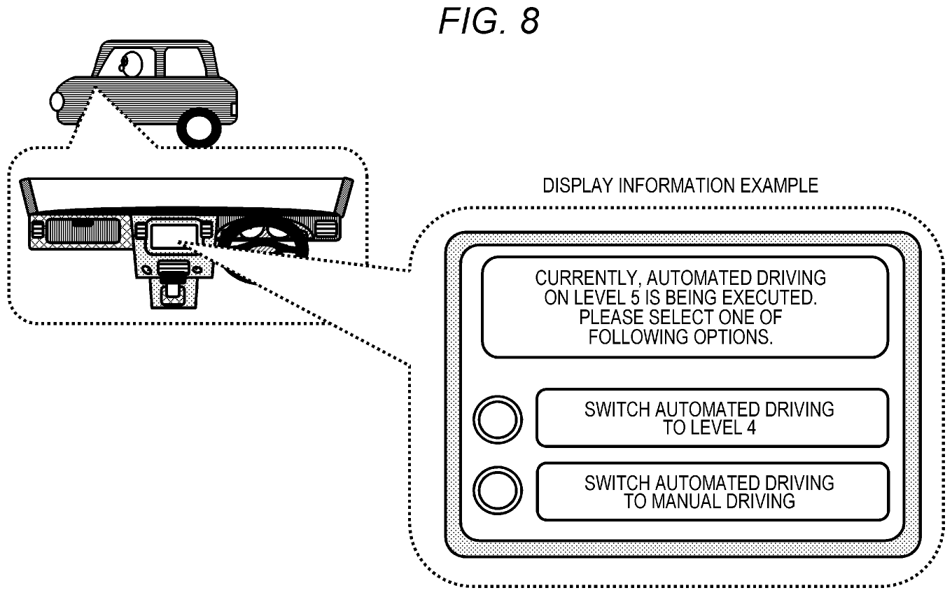

FIG. 8 illustrates an example of specific display data.

As illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.”

Further, the following options are displayed.
Switch automated driving to level 4
Switch automated driving to manual driving

The driver who is the user sees the message displayed on the display unit and selects one of the options.

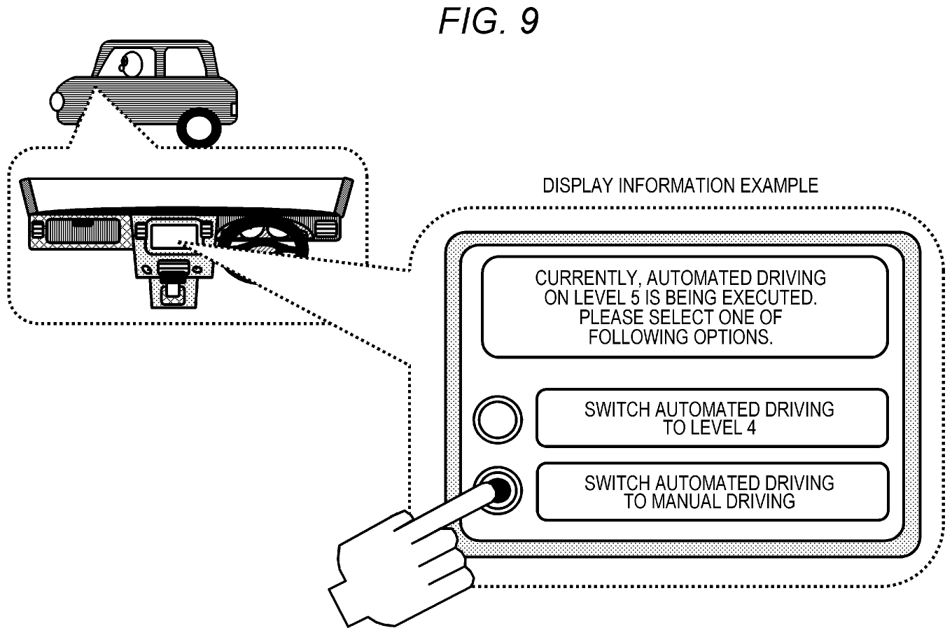

For example, as illustrated in FIG. 9, the user who wishes to switch the automated driving to the manual driving selects the lower option:
Switch automated driving to manual driving

In this manner, the user inputs selection information of one of the two options displayed on the display unit.

Note that the notification is not limited to the display data illustrated in FIGS. 8 and 9, and may be performed by, for example, voice information.

(Step S107)

In step S107, the driving assistance processing unit 122 in the control unit 120 inputs user selection information for the downward shift control of the automated driving level displayed on the display unit in step S106 or the switching selection request data to the manual driving, and determines whether or not the selection by the user is the switching to the manual driving.

In a case where the selection by the user is the switching to the manual driving, the processing proceeds to step S108.

On the other hand, in a case where the selection by the user is not the switching to the manual driving but level downward shift control of the automated driving level, the processing proceeds to step S109.

(Step S108)

In a case where it is determined in step S107 that the selection by the user is the switching to the manual driving, the processing of step S108 is executed.

In this case, in step S108, the driving assistance processing unit 122 in the control unit 120 stops the currently executed automated driving and executes the switching to the manual driving.

(Step S109)

On the other hand, in a case where the selection by the user is not the switching to the manual driving but the level downward shift control of the automated driving level in step S107, the processing of step S109 is executed.

In this case, in step S109, the driving assistance processing unit 122 in the control unit 120 executes processing for performing the downward shift control of the level of the automated driving currently being executed.

In a case where the level of the automated driving currently being executed is level 5, processing of switching to the automated driving of level 4 or the like is executed.

Note that the downward shift level may be set to be changed according to the difference between the observation information and the external information compared in step S103, for example.

For example, processing may be performed such that the downward shift level of the automated driving level is set to 1 level in a case where the difference is small, and the downward shift level of the automated driving level is set to 2 to 3 level in a case where the difference is large.

(Step S111)

The processing of step S111 is processing performed in a case where the moving apparatus is currently executing manual driving instead of automated driving in step S105.

In this case, the driving assistance processing unit 122 in the control unit 120 performs warning information notification processing in step S111.

For example, warning information is displayed on the display unit of the moving apparatus.

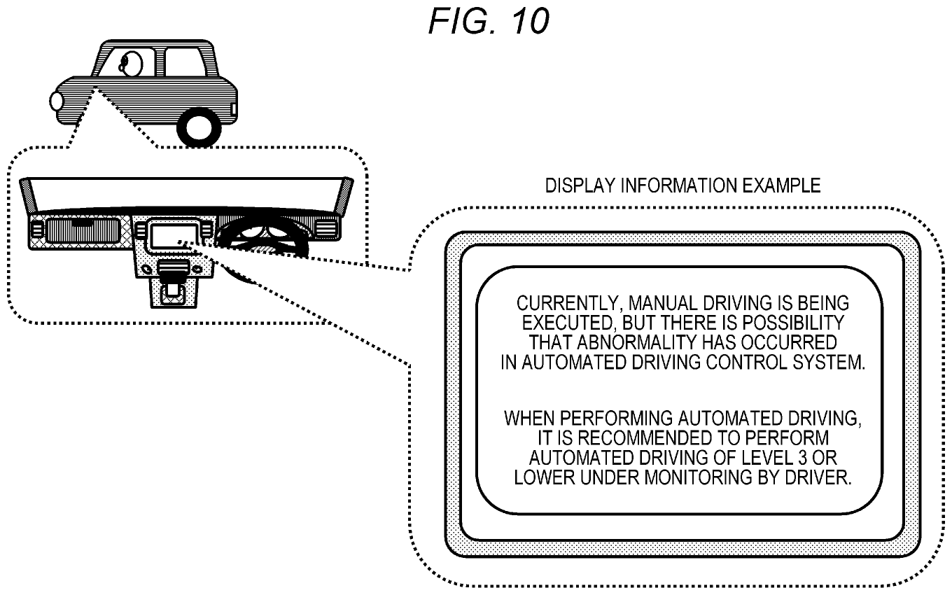

FIG. 10 illustrates an example of specific display data.

As illustrated in FIG. 10, the warning information is displayed on the display unit that can be observed by the driver (operator) of the moving apparatus.

The display information example illustrated in FIG. is an example in which the following message is displayed.

“Currently, manual driving is being executed, but there is a possibility that an abnormality has occurred in the automated driving control system. When performing automated driving, it is recommended to perform automated driving of Level 3 or lower under monitoring by driver.”

The driver, who is the user, recognizes that there is a possibility that an abnormality has occurred in the automated driving control system by looking at the message displayed on the display unit, and can take a measure such as stopping the shift to the automated driving or performing the low-level automated driving and paying close attention during the automated driving.

### 4. Specific Example of Processing Executed by Information Processing Device of Present Disclosure

Next, a specific example of processing executed by the information processing device of the present disclosure will be described.

The processing sequence described with reference to the flowchart illustrated in FIG. 7 is a basic sequence of processing executed by the information processing device 100 attached to the moving apparatus 11.

Hereinafter, a following plurality of specific processing examples below will be sequentially described.

(Processing Example 1) Processing example in case where acquired information of data collection unit and external information acquired from external device are distance information between moving apparatus and dividing line (stop line, lane, or the like)

(Processing Example 2) Processing example of comparing map information acquired from storage unit by driving assistance processing unit with map information acquired from map information provision server as external device

(Processing Example 3) Processing example in case where acquired information of data collection unit and external information acquired from external device are inter-vehicle distance information

(Processing Example 4) Processing example of analyzing operation status of moving apparatus using acquired information of data collection unit and external information acquired from external device

(Processing Example 5) Processing example of analyzing road sign and road surface display using acquired information of data collection unit and external information acquired from external device

(Processing Example 6) Driving control processing example according to distance calculation result between moving apparatus and stop line based on acquired information of data collection unit

### 4-1. (Processing Example 1) Processing Example in Case where Acquired Information of Data Collection Unit and External Information Acquired from External Device are Distance Information Between Moving Apparatus and Dividing Line (Stop Line, Lane, or the Like

First, as (Processing Example 1), a processing example in a case where acquired information of the data collection unit and the external information acquired from the external device are distance information between the moving apparatus and a dividing line (stop line, lane, or the like) will be described.

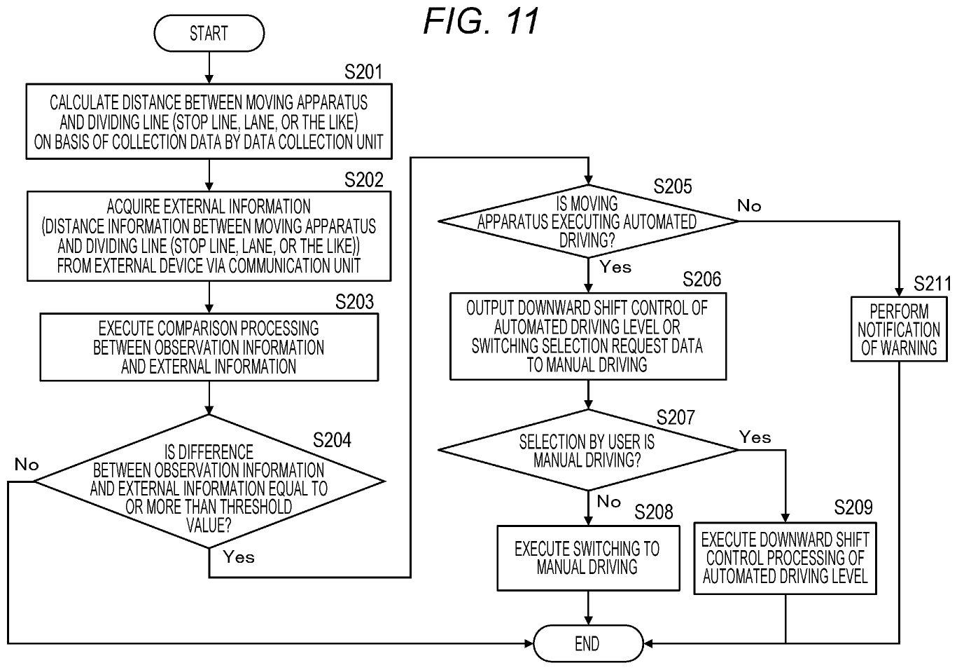

A sequence of processing executed by the information processing device 100 of the present disclosure, that is, the information processing device 100 attached to the moving apparatus 11 in a case where the acquired information of the data collection unit and the external information acquired from the external device are the distance information between the moving apparatus and the dividing line (stop line, lane, or the like) will be described with reference to a flowchart illustrated in FIG. 11.

Hereinafter, processing of each step of the flowchart illustrated in FIG. 11 will be sequentially described.

(Step S201)

First, in step S201, the control unit 120 of the information processing device 100 calculates a distance between the moving apparatus and a dividing line (stop line, lane, or the like) recorded on a road on the basis of the collection data by the data collection unit 121, that is, the sensor detection information (=observation information) acquired by the sensor unit 131.

This processing is executed by the data collection unit 121 and the driving assistance processing unit 122 in the control unit 120 of the information processing device 100.

Note that the dividing line is a line such as a center line drawn on a road surface, a lane boundary line, or a boundary line with a roadside strip. The dividing line includes a white solid line, a broken line, or a yellow solid line or a broken line.

The driving assistance processing unit 122 calculates the distance between the moving apparatus and the dividing line recorded on the road on the basis of the information collected by the data collection unit 121. For example, the distance between the moving apparatus and the dividing line recorded on the road is calculated on the basis of the camera-captured image and the object distance information collected by the data collection unit 121.

(Step S202)

Next, in step S202, the control unit 120 of the information processing device 100 acquires the distance information between the moving apparatus and the dividing line recorded on the road from the external device via the communication unit 110.

This processing is executed by the communication unit 110 of the information processing device 100 and the driving assistance processing unit 122 in the control unit 120.

The driving assistance processing unit 122 in the control unit 120 acquires the distance information between the moving apparatus and the dividing line recorded on the road from the external device via the communication unit 110.

Note that, as described above with reference to the flow of FIG. 7, the external device is, for example, another moving apparatus that travels in the vicinity of the host vehicle, such as in front of or behind the host vehicle, the roadside communication unit which is the road infrastructure in the vicinity of the host vehicle, or the external server (driving management server, calculation server, map information provision server, or the like).

For example, a camera provided in a roadside communication unit which is a road infrastructure captures an image of the moving apparatus and the dividing line recorded on the road, this image is transmitted to the driving management server 21, and the driving management server 21 calculates the distance between the moving apparatus and the dividing line recorded on the road.

The driving assistance processing unit 122 can acquire the calculated distance information from the driving management server 21 via the communication unit 110.

Alternatively, it is also possible to receive and acquire the distance information (distance between the moving apparatus and the dividing line recorded on the road) calculated by analyzing the captured image of the rear camera in another moving apparatus traveling ahead via the communication unit 110 by V2V communication.

As described above, in step S202, the driving assistance processing unit 122 in the control unit 120 acquires the “distance information between the moving apparatus and the dividing line recorded on the road” as the external information from the external device via the communication unit 110.

(Step S203)

Next, in step S203, the driving assistance processing unit 122 in the control unit 120 executes comparison processing between the self-calculated distance information calculated in step S201 (distance information between the moving apparatus and the dividing line recorded on the road) and the externally acquired distance information acquired from the external device in step S202 (distance information between the moving apparatus and the dividing line recorded on the road).

That is, the driving assistance processing unit 122 in the control unit 120 executes comparison processing between the following two pieces of information.
(a) Self-calculated distance information calculated in step S201 (distance information between moving apparatus and dividing line recorded on road)
(b) Externally acquired distance information acquired from an external device in step S202 (distance information between moving apparatus and dividing line recorded on road)

(Step S204)

Next, in step S204, the determination unit 123 in the control unit 120 determines whether or not a difference between the self-calculated distance information calculated in step S201 and the externally acquired distance information acquired from the external device in step S202 is equal to or more than the predetermined threshold value.

In a case where it is determined in step S204 that the difference is equal to or more than the predetermined threshold value, the processing proceeds to step S205.

On the other hand, in a case where it is determined in step S204 that the difference is less than the predetermined threshold value, the processing is ended.

In this case, since the self-calculated distance information calculated in step S201 (distance information between the moving apparatus and the dividing line recorded on the road) substantially matches the acquired information from the outside, it is determined that the accuracy of the observation information in the data collection unit 121 is high and safe automated driving is possible, and the processing is ended without performing the processing of step S205 and subsequent steps.

On the other hand, in a case where the self-calculated distance information calculated in step S201 (distance information between the moving apparatus and the dividing line recorded on the road) has a large difference from the acquired information from the outside, it is determined that the accuracy of the distance information calculated in step S201 is low and safe automated driving cannot be performed, and the processing of step S205 and subsequent steps is performed.

(Step S205)

The processing of step S205 and subsequent steps is executed in a case where it is determined in step S204 that the difference between the self-calculated distance information (distance information between the moving apparatus and the dividing line recorded on the road) and the distance information acquired from the external device is equal to or more than the predetermined threshold value.

In this case, in step S205, the driving assistance processing unit 122 in the control unit 120 determines whether or not the moving apparatus is currently executing automated driving.

In a case where the moving apparatus is executing automated driving, the processing proceeds to step S206.

On the other hand, in a case where the moving apparatus is executing manual driving instead of automated driving, the processing proceeds to step S211.

(Step S206)

The processing of step S206 and subsequent steps is processing executed in a case where the moving apparatus is executing automated driving in step S205.

In a case where the moving apparatus is executing the automated driving, first, in step S206, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.” Further, the following options are displayed.
Switch automated driving to level 4
Switch automated driving to manual driving

The driver who is the user sees the message displayed on the display unit and selects one of the options.

(Step S207)

In step S207, the driving assistance processing unit 122 in the control unit 120 inputs the user selection information for the downward shift control of the automated driving level displayed on the display unit in step S206 or the switching selection request data to the manual driving, and determines whether or not the selection by the user is the switching to the manual driving.

In a case where the selection by the user is the switching to the manual driving, the processing proceeds to step S208.

On the other hand, in a case where the selection by the user is not the switching to the manual driving but the level downward shift control of the automated driving level, the processing proceeds to step S209.

(Step S208)

In a case where it is determined in step S207 that the selection by the user is the switching to the manual driving, the processing of step S208 is executed.

In this case, in step S208, the driving assistance processing unit 122 in the control unit 120 stops the currently executed automated driving and executes the switching to the manual driving.

(Step S209)

On the other hand, in a case where the selection by the user is not the switching to the manual driving but the level downward shift control of the automated driving level in step S207, the processing of step S209 is executed.

In this case, in step S209, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S203, for example.

For example, processing may be performed such that the downward shift level of the automated driving level is set to 1 level in a case where the difference is small, and the downward shift level of the automated driving level is set to 2 to 3 level in a case where the difference is large.

(Step S211)

The processing of step S211 is the processing performed in a case where the moving apparatus is currently executing manual driving instead of automated driving in step S205.

In this case, the driving assistance processing unit 122 in the control unit 120 performs the warning information notification processing in step S211.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 4-2. (Processing Example 2) Processing Example of Comparing Map Information Acquired from Storage Unit by Driving Assistance Processing Unit with Map Information Acquired from Map Information Provision Server as External Device

Next, as (Processing Example 2), a processing example of comparing the map information acquired from the storage unit by the driving assistance processing unit with the map information acquired from the map information provision server as the external device will be described.

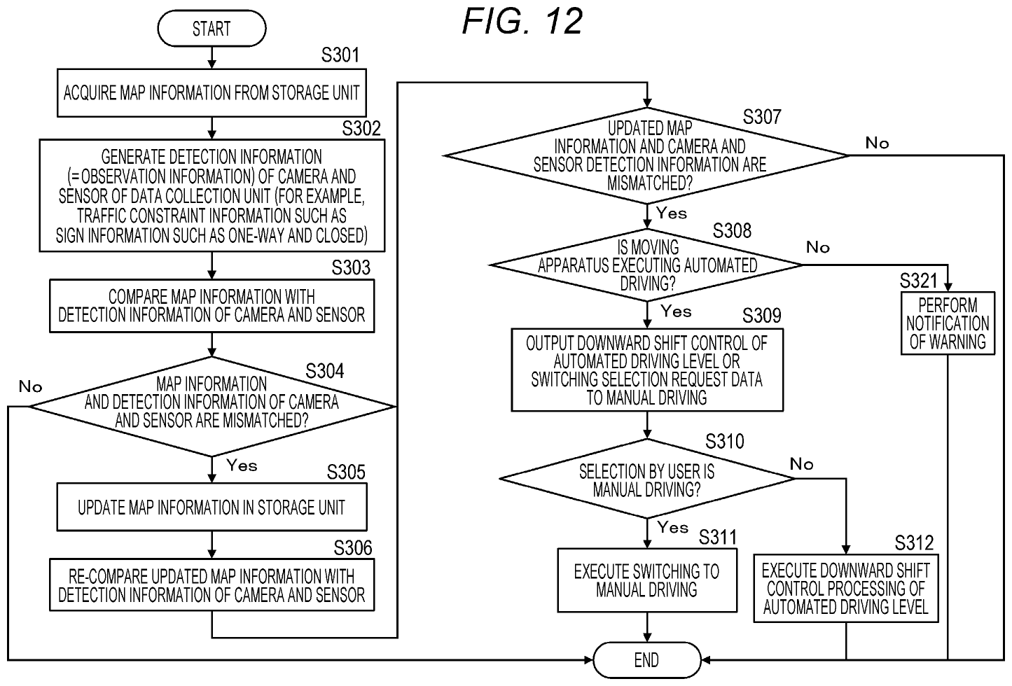

A sequence of processing executed by the information processing device 100 of the present disclosure, that is, the information processing device 100 attached to the moving apparatus 11 in a case where the driving assistance processing unit performs processing of comparing the map information acquired from the storage unit with the map information acquired from the map information provision server which is an external device will be described with reference to a flowchart illustrated in FIG. 12.

Hereinafter, processing of each step of the flowchart illustrated in FIG. 12 will be sequentially described.

(Step S301)

First, in step S301, the control unit 120 of the information processing device 100 acquires map information stored in the storage unit 132.

This processing is executed by the data collection unit 121 and the driving assistance processing unit 122 in the control unit 120 of the information processing device 100.

Note that the map information stored in the storage unit 132 is, for example, a local dynamic map (LDM) provided by the map information provision server 23.

As described above, the map information provision server 23 generates what is called a local dynamic map (LDM) that constantly updates, for example, the traveling map information of the road on which the vehicle travels at high density, and provides the generated map to the moving apparatus 11.

As described above with reference to FIG. 3, the LDM includes information groups of a plurality of types of hierarchical layers. The map information provision server 23 continuously executes update processing of the local dynamic map (LDM) based on the latest information, and each moving apparatus 11 can acquire the latest information from the server and use the information at the time of using the LDM.

However, under the present circumstances, the section in which the automated driving vehicle can perform automated driving using the LDM information is a limited section such as a partial section of an expressway, and there are many sections in which manual driving by the driver is required. In addition, the current LDM may not be updated in a timely manner, and in such a case, manual driving by the driver is required.

(Step S302)

Next, in step S302, the control unit 120 of the information processing device 100 generates observation information (for example, traffic constraint information such as sign information such as one-way, closed, right turn prohibited, and left turn prohibited, and traveling road information) based on camera and the sensor detection information acquired from the sensor unit 131.

This processing is executed by the communication unit 110 of the information processing device 100 and the driving assistance processing unit 122 in the control unit 120.

The driving assistance processing unit 122 in the control unit 120 inputs detection information (image information, object distance information, or the like) of the camera, the sensor, and the like acquired by the sensor unit 131 from the data collection unit 121, and generates observation information (for example, traffic constraint information such as sign information such as one-way, closed, right turn prohibited, and left turn prohibited, and traveling road information) on the basis of the input information.

(Step S303)

Next, in step S303, the driving assistance processing unit 122 in the control unit 120 executes comparison processing between the map information acquired from the storage unit 132 in step S301 and the observation information (for example, traffic constraint information such as sign information such as one-way, closed, right turn prohibited, and left turn prohibited, and traveling road information) generated on the basis of the detection information (image information, object distance information, or the like) of the camera, the sensor, and the like in step S302.

(Step S304)

Next, in step S304, the determination unit 123 in the control unit 120 determines whether or not the map information acquired from the storage unit 132 in step S301 matches the observation information (for example, traffic constraint information such as sign information such as one-way, closed, right turn prohibited, and left turn prohibited, and traveling road information) generated on the basis of the detection information of the sensor unit 131 in step S302.

Specifically, for example, it is checked whether or not a “road closed sign” included in the observation information generated on the basis of the detection information of the sensor unit 131 (=collection information of the data collection unit 121) is also recorded in the map information acquired from the storage unit 132, or the like.

For example, in a case where it is confirmed that the “road closed sign” included in the observation information generated on the basis of the detection information of the sensor unit 131 (=collection information of the data collection unit 121) is also recorded in the map information acquired from the storage unit 132, it is determined that the observation information and the map information match.

On the other hand, in a case where it is confirmed that the “road closed sign” included in the observation information generated on the basis of the detection information of the sensor unit 131 (=collection information of the data collection unit 121) is not recorded in the map information acquired from the storage unit 132, it is determined that the observation information and the map information do not match.

In a case where it is determined in step S304 that the observation information and the map information do not match, the processing proceeds to step S305.

On the other hand, in a case where it is determined in step S304 that the observation information matches the map information, the processing is ended.

In this case, since the observation information matches the map information, it is determined that safe driving according to the observation information is possible, and the processing is ended without performing the processing of step S305 and subsequent steps.

On the other hand, in a case where it is determined that the observation information and the map information do not match, it is determined that safe driving according to the observation information cannot be performed, and the processing of step S305 and subsequent steps is performed.

(Step S305)

The processing of step S305 and subsequent steps is executed in a case where it is determined in step S304 that the observation information and the map information do not match.

In this case, in step S305, the control unit 120 executes update processing of the map information stored in the storage unit 132.

As described above, the map information stored in the storage unit 132 is, for example, the local dynamic map (LDM) provided by the map information provision server 23.

Since there is a possibility that the map information is not the latest one, in step S305, the control unit 120 accesses the map information provision server 23 via the communication unit 110, acquires the latest local dynamic map (LDM) from the map information provision server 23, and executes update processing of the map information stored in the storage unit 132.

(Step S306)

Next, in step S306, the driving assistance processing unit 122 in the control unit 120 executes comparison processing between the updated map information stored in the storage unit 132 in step S305 and the observation information (for example, traffic constraint information such as sign information such as one-way, closed, right turn prohibited, and left turn prohibited, and traveling road information) generated on the basis of the detection information (image information, object distance information, or the like) of the sensor unit 131 of the camera, the sensor, and the like in step S302.

(Step S307)

Next, in step S307, the determination unit 123 in the control unit 120 determines whether or not the updated map information stored in the storage unit 132 in step S305 matches the observation information (for example, traffic constraint information such as sign information such as one-way, closed, right turn prohibited, and left turn prohibited, and traveling road information) generated on the basis of the detection information of the sensor unit 131 (=the collection information of the data collection unit 121) in step S302.

Specifically, for example, it is checked whether or not the “road closed sign” included in the observation information generated on the basis of the detection information of the sensor unit 131 (=collection information of the data collection unit 121) is also recorded in the updated map information stored in the storage unit 132, or the like.

For example, in a case where it is confirmed that the “road closed sign” included in the observation information generated on the basis of the detection information of the sensor unit 131 (=collection information of the data collection unit 121) is also recorded in the updated map information stored in the storage unit 132, it is determined that the observation information and the updated map information match.

On the other hand, in a case where it is confirmed that the “road closed sign” included in the observation information generated on the basis of the detection information of the sensor unit 131 (=collection information of the data collection unit 121) is not recorded in the updated map information stored in the storage unit 132, it is determined that the observation information and the map information do not match.

In a case where it is determined in step S307 that the observation information and the updated map information do not match, the processing proceeds to step S308.

On the other hand, in a case where it is determined in step S307 that the observation information matches the updated map information, the processing is ended.

In this case, since the observation information matches the updated map information, it is determined that safe driving according to the observation information is possible, and the processing is ended without performing the processing of step S308 and subsequent steps.

On the other hand, in a case where it is determined that the observation information and the updated map information do not match, it is determined that safe driving according to the observation information cannot be performed, and the processing of step S308 and subsequent steps is performed.

Note that, in a case where the update processing of the map information in S305 is executed for each hierarchical layer constituting the local dynamic map (LDM), the processing from S304 to S307 may be repeated for each layer. For example, in the first processing, control may be performed to preferentially perform on a layer in which included information is more dynamic, such as performing on a layer including dynamic data and subsequently performing on a layer including semi-dynamic data.

(Step S308)

The processing of step S308 and subsequent steps is executed in a case where it is determined in step S307 that the observation information and the updated map information do not match.

In this case, in step S308, the control unit 120 determines whether or not the moving apparatus is currently executing automated driving.

In a case where the moving apparatus is executing automated driving, the processing proceeds to step S309.

On the other hand, in a case where the moving apparatus is executing manual driving instead of automated driving, the processing proceeds to step S321.

(Step S309)

The processing of step S309 and subsequent steps is the processing executed in a case where the moving apparatus is executing automated driving in step S308.

In a case where the moving apparatus is performing the automated driving, first, in step S309, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.” Further, the following options are displayed.
Switch automated driving to level 4
Switch automated driving to manual driving

The driver who is the user sees the message displayed on the display unit and selects one of the options.

(Step S310)

In step S310, the driving assistance processing unit 122 in the control unit 120 inputs the user selection information for the downward shift control of the automated driving level displayed on the display unit in step S309 or the switching selection request data to the manual driving, and determines whether or not the selection by the user is the switching to the manual driving.

In a case where the selection by the user is the switching to the manual driving, the processing proceeds to step S311.

On the other hand, in a case where the selection by the user is not the switching to the manual driving but the level downward shift control of the automated driving level, the processing proceeds to step S312.

(Step S311)

In a case where it is determined in step S310 that the selection by the user is the switching to the manual driving, the processing of step S311 is executed.

In this case, in step S311, the driving assistance processing unit 122 in the control unit 120 stops the currently executed automated driving and executes the switching to the manual driving.

(Step S312)

On the other hand, in a case where the selection by the user is not the switching to the manual driving but the level downward shift control of the automated driving level in step S310, the processing of step S312 is executed.

In this case, in step S312, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S303, for example.

For example, processing may be performed such that the downward shift level of the automated driving level is set to 1 level in a case where the difference is small, and the downward shift level of the automated driving level is set to 2 to 3 level in a case where the difference is large. Here, as the difference between the observation information and the external information compared in step S303, in a case where highly important sign information or traffic constraint information, for example, sign information such as one-way, closed, right turn prohibited, or left turn prohibited, is not included in either the observation information or the external information, it may be determined that the difference is large, and in a case where the less important sign information or traffic constraint information is not included in either the observation information or the external information, it may be determined that the difference is small. That is, different importance levels are assigned to the sign information and the traffic constraint information.

(Step S321)

The processing of step S321 is the processing performed in a case where the moving apparatus is currently executing manual driving instead of automated driving in step S308.

In this case, the driving assistance processing unit 122 in the control unit 120 performs the warning information notification processing in step S321.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 4-3. (Processing Example 3) Processing Example in Case where Acquired Information of Data Collection Unit and External Information Acquired from External Device are Inter-Vehicle Distance Information

Next, as (Processing Example 3), a processing example in a case where the acquired information of the data collection unit and the external information acquired from the external device are the inter-vehicle distance information will be described.

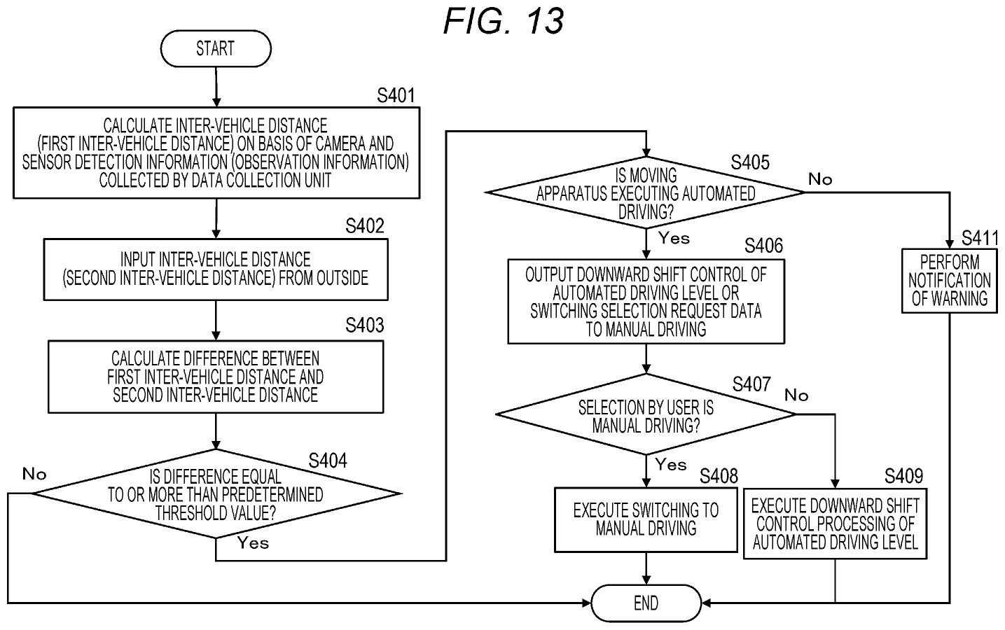

A sequence of processing executed by the information processing device 100 of the present disclosure, that is, the information processing device 100 attached to the moving apparatus 11 in a case where the acquired information of the data collection unit and the external information acquired from the external device are inter-vehicle distance information will be described with reference to a flowchart illustrated in FIG. 13.

Hereinafter, processing of each step of the flowchart illustrated in FIG. 13 will be sequentially described.

(Step S401)

First, in step S401, the control unit 120 of the information processing device 100 calculates an inter-vehicle distance (first inter-vehicle distance) on the basis of the collection data by the data collection unit 121, that is, the camera and sensor detection information of the sensor unit 131.

This processing is executed by the data collection unit 121 and the driving assistance processing unit 122 in the control unit 120 of the information processing device 100.

The driving assistance processing unit 122 calculates an inter-vehicle distance between the moving apparatus and another vehicle ahead of the moving apparatus on the basis of the information collected by the data collection unit 121. For example, the inter-vehicle distance between the moving apparatus and another vehicle ahead of the moving apparatus is calculated on the basis of the camera-captured image and the object distance information collected by the data collection unit 121.

(Step S402)

Next, in step S402, the control unit 120 of the information processing device 100 acquires an inter-vehicle distance (second inter-vehicle distance) between the moving apparatus and another vehicle ahead of the moving apparatus from the external device via the communication unit 110.

This processing is executed by the communication unit 110 of the information processing device 100 and the driving assistance processing unit 122 in the control unit 120.

The driving assistance processing unit 122 in the control unit 120 acquires an inter-vehicle distance (second inter-vehicle distance) between the moving apparatus and another vehicle ahead of the moving apparatus from the external device via the communication unit 110.

Note that, as described above with reference to the flow of FIG. 7, the external device is, for example, another moving apparatus that travels in the vicinity of the host vehicle, such as in front of or behind the host vehicle, the roadside communication unit (RSU) which is the road infrastructure in the vicinity of the host vehicle, or the external server (driving management server, calculation server, map information provision server, or the like).

For example, the camera provided in the roadside communication unit (RSU) which is the road infrastructure captures an image of the moving apparatus and another vehicle ahead of the moving apparatus, this image is transmitted to the driving management server 21, and the driving management server 21 calculates the inter-vehicle distance between the moving apparatus and the another vehicle ahead of the moving apparatus.

The driving assistance processing unit 122 can acquire the inter-vehicle distance information from the driving management server 21 via the communication unit 110.

Alternatively, it is also possible to receive and acquire distance information (inter-vehicle distance between the moving apparatuses) calculated by analyzing a captured image of a rear camera in another moving apparatus traveling ahead via the communication unit 110 by V2V communication.

As described above, in step S402, the driving assistance processing unit 122 in the control unit 120 acquires “distance information of inter-vehicle distance between moving apparatus and another vehicle in front of moving apparatus” as the external information (second inter-vehicle distance) from the external device via the communication unit 110.

(Step S403)

Next, in step S403, the driving assistance processing unit 122 in the control unit 120 executes comparison processing between the self-calculated inter-vehicle distance (first inter-vehicle distance) calculated in step S401 and the externally acquired inter-vehicle distance (second inter-vehicle distance) acquired from the external device in step S402.

That is, the driving assistance processing unit 122 in the control unit 120 executes comparison processing between the following two pieces of information.
(a) Self-calculated inter-vehicle distance (first inter-vehicle distance) calculated in step S401
(b) Externally acquired inter-vehicle distance (second inter-vehicle distance) acquired from external device in step S402

(Step S404)

Next, in step S404, the determination unit 123 in the control unit 120 determines whether or not a difference between the self-calculated inter-vehicle distance (first inter-vehicle distance) calculated in step S401 and the externally acquired inter-vehicle distance (second inter-vehicle distance) acquired from the external device in step S402 is equal to or more than a predetermined threshold value.

In a case where it is determined in step S404 that the difference is equal to or more than the predetermined threshold value, the processing proceeds to step S405.

On the other hand, in a case where it is determined in step S404 that the difference is less than the predetermined threshold value, the processing is ended.

In this case, since the self-calculated distance (first inter-vehicle distance) calculated in step S401 substantially matches the externally acquired inter-vehicle distance (second inter-vehicle distance) acquired from the outside, it is determined that the accuracy of the observation information acquired from the data collection unit 121 is high and safe automated driving is possible, and the processing is ended without performing the processing of step S405 and subsequent steps.

On the other hand, in a case where the self-calculated distance (first inter-vehicle distance) calculated in step S401 has a large difference from the externally acquired inter-vehicle distance (second inter-vehicle distance) acquired from the outside, it is determined that the accuracy of the first inter-vehicle distance information calculated in step S401 is low and safe automated driving cannot be performed, and the processing of step S405 and subsequent steps is performed.

(Step S405)

The processing of step S405 and subsequent steps is executed in a case where it is determined in step S404 that the self-calculated distance (first inter-vehicle distance) is equal to or more than the predetermined threshold value, and the externally acquired inter-vehicle distance (second inter-vehicle distance) acquired from the outside is equal to or more than the predetermined threshold value.

In this case, in step S405, the driving assistance processing unit 122 in the control unit 120 determines whether or not the moving apparatus is currently executing automated driving.

In a case where the moving apparatus is executing automated driving, the processing proceeds to step S406.

On the other hand, in a case where the moving apparatus is executing manual driving instead of automated driving, the processing proceeds to step S411.

(Step S406)

The processing of step S406 and subsequent steps is the processing executed in a case where the moving apparatus is executing automated driving in step S405.

In a case where the moving apparatus is performing the automated driving, first, in step S406, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.” Further, the following options are displayed.
Switch automated driving to level 4
Switch automated driving to manual driving

The driver who is the user sees the message displayed on the display unit and selects one of the options.

(Step S407)

In step S407, the driving assistance processing unit 122 in the control unit 120 inputs the user selection information for the downward shift control of the automated driving level displayed on the display unit in step S406 or the switching selection request data to the manual driving, and determines whether or not the selection by the user is the switching to the manual driving.

In a case where the selection by the user is the switching to the manual driving, the processing proceeds to step S408.

On the other hand, in a case where the selection by the user is not the switching to the manual driving but the level downward shift control of the automated driving level, the processing proceeds to step S409.

(Step S408)

In a case where it is determined in step S407 that the selection by the user is the switching to the manual driving, the processing of step S408 is executed.

In this case, in step S408, the driving assistance processing unit 122 in the control unit 120 stops the currently executed automated driving and executes the switching to the manual driving.

(Step S409)

On the other hand, in a case where the selection by the user is not the switching to the manual driving but the level downward shift control of the automated driving level in step S407, the processing of step S409 is executed.

In this case, in step S409, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S403, for example.

For example, processing may be performed such that the downward shift level of the automated driving level is set to 1 level in a case where the difference is small, and the downward shift level of the automated driving level is set to 2 to 3 level in a case where the difference is large.

(Step S411)

The processing of step S411 is the processing performed in a case where the moving apparatus is currently executing manual driving instead of automated driving in step S405.

In this case, the driving assistance processing unit 122 in the control unit 120 performs the warning information notification processing in step S411.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 4-4. (Processing Example 4) Processing Example of Analyzing Operation Status of Moving Apparatus Using Acquired Information of Data Collection Unit and External Information Acquired from External Device

Next, as (Processing Example 4), a processing example of analyzing the operation status of the moving apparatus using the acquired information of the data collection unit and the external information acquired from the external device will be described.

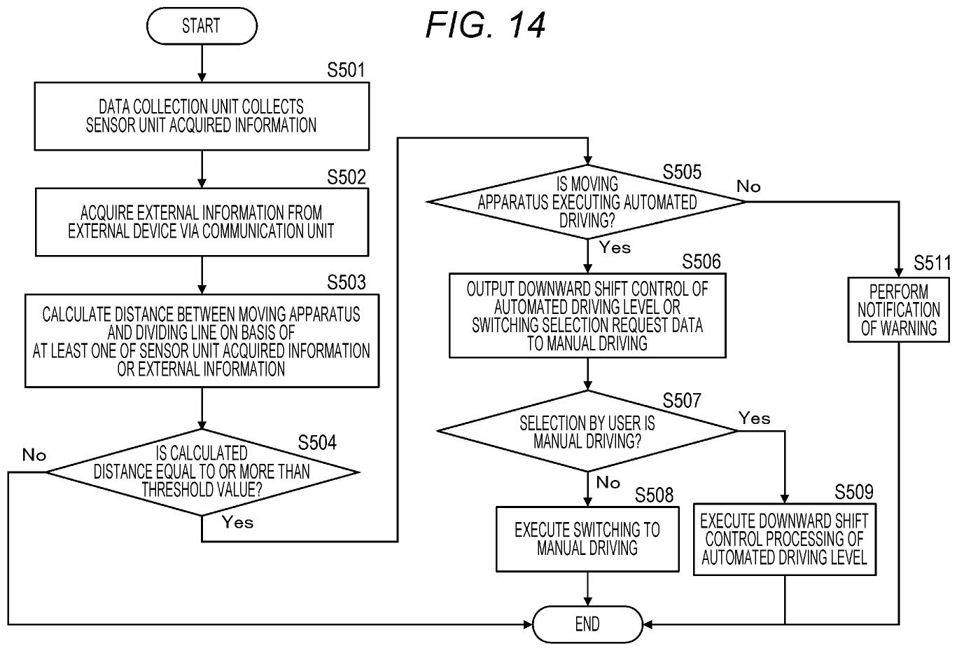

A sequence of processing executed by the information processing device 100 of the present disclosure, that is, the information processing device 100 attached to the moving apparatus 11 in a case where a processing example of analyzing the operation status of the moving apparatus using the acquired information of the data collection unit and the external information acquired from the external device is executed will be described with reference to a flowchart illustrated in FIG. 14.

Hereinafter, processing of each step of the flowchart illustrated in FIG. 14 will be sequentially described.

(Step S501)

In the control unit 120 of the information processing device 100, first, in step S501, the data collection unit 121 collects the sensor detection information acquired by the sensor unit 131.

(Step S502)

Next, in step S502, the control unit 120 of the information processing device 100 acquires the external information from the external device via the communication unit 110.

This processing is executed by the communication unit 110 of the information processing device 100 and the driving assistance processing unit 122 in the control unit 120.

The driving assistance processing unit 122 in the control unit 120 acquires the external information from the external device via the communication unit 110.

Note that, as described above with reference to the flow of FIG. 7, the external device is, for example, another moving apparatus that travels in the vicinity of the host vehicle, such as in front of or behind the host vehicle, the roadside communication unit which is the road infrastructure in the vicinity of the host vehicle, or the external server (driving management server, calculation server, map information provision server, or the like).

The external information acquired from the external device is, for example, image information acquired by a camera provided in another moving apparatus or the roadside communication unit which is the road infrastructure, distance information between the moving apparatus and the dividing line recorded on the road, or the like, which is calculated on the basis of the image information.

As described above, in step S502, the driving assistance processing unit 122 in the control unit 120 acquires the external information from the external device via the communication unit 110.

(Step S503)

Next, in step S503, the driving assistance processing unit 122 in the control unit 120 calculates the distance between the moving apparatus and the dividing line recorded on the road by using at least one of the sensor detection information of the sensor unit 131 acquired in step S501 or the external information acquired from the external device in step S502. For example, the distance between the moving apparatus and the dividing line recorded on the road is calculated using the camera-captured image and the object distance information collected by the data collection unit 121 and the external information acquired from the external device, for example, a camera-captured image of another vehicle, and the like.

(Step S504)

Next, in step S504, the determination unit 123 in the control unit 120 determines whether or not the distance between the moving apparatus calculated in step S503 and the dividing line recorded on the road is equal to or more than a predetermined threshold value.

In a case where the distance between the moving apparatus and the dividing line is equal to or more than the predetermined threshold value, it is determined that the driving accuracy is not good, and the processing of step S505 and subsequent steps is executed.

On the other hand, in a case where the distance between the moving apparatus and the dividing line is not equal to or more than the predetermined threshold value, it is determined that the driving accuracy is good, and the processing is ended without executing the processing of step S505 and subsequent steps.

(Step S505)

The processing of step S505 and subsequent steps is executed in a case where it is determined in step S504 that the distance between the moving apparatus and the dividing line is equal to or more than the predetermined threshold value and the driving accuracy is not good.

In this case, in step S505, the driving assistance processing unit 122 in the control unit 120 determines whether or not the moving apparatus is currently executing automated driving.

In a case where the moving apparatus is executing automated driving, the processing proceeds to step S506.

On the other hand, in a case where the moving apparatus is executing manual driving instead of automated driving, the processing proceeds to step S511.

(Step S506)

The processing of step S506 and subsequent steps is the processing executed in a case where the moving apparatus is executing automated driving in step S505.

In a case where the moving apparatus is performing the automated driving, first, in step S506, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.” Further, the following options are displayed.
Switch automated driving to level 4
Switch automated driving to manual driving

The driver who is the user sees the message displayed on the display unit and selects one of the options.

(Step S507)

In step S507, the driving assistance processing unit 122 in the control unit 120 inputs the user selection information for the downward shift control of the automated driving level displayed on the display unit in step S506 or the switching selection request data to the manual driving, and determines whether or not the selection by the user is the switching to the manual driving.

In a case where the selection by the user is the switching to the manual driving, the processing proceeds to step S508.

On the other hand, in a case where the selection by the user is not the switching to the manual driving but the level downward shift control of the automated driving level, the processing proceeds to step S509.

(Step S508)

In a case where it is determined in step S507 that the selection by the user is the switching to the manual driving, the processing of step S508 is executed.

In this case, in step S508, the driving assistance processing unit 122 in the control unit 120 stops the currently executed automated driving and executes the switching to the manual driving.

(Step S509)

On the other hand, in a case where the selection by the user is not the switching to the manual driving but the level downward shift control of the automated driving level in step S507, the processing of step S509 is executed.

In this case, in step S509, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S503, for example.

For example, processing may be performed such that the downward shift level of the automated driving level is set to 1 level in a case where the difference is small, and the downward shift level of the automated driving level is set to 2 to 3 level in a case where the difference is large.

(Step S511)

The processing of step S511 is the processing performed in a case where the moving apparatus is currently executing manual driving instead of automated driving in step S505.

In this case, the driving assistance processing unit 122 in the control unit 120 performs the warning information notification processing in step S511.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 4-5. (Processing Example 5) Processing Example of Analyzing Road Sign and Road Surface Display Using Acquired Information of Data Collection Unit and External Information Acquired from External Device

Next, as (Processing Example 5), a processing example of analyzing a road sign and a road surface display using the acquired information of the data collection unit and external information acquired from an external device will be described.

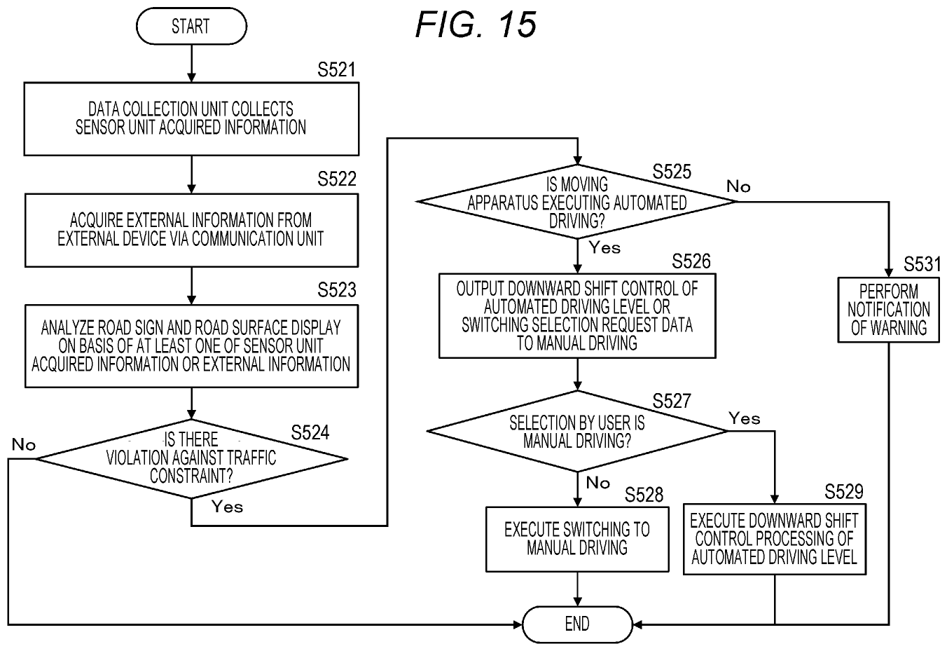

A sequence of processing executed by the information processing device 100 of the present disclosure, that is, the information processing device 100 attached to the moving apparatus 11 in a case where a processing example of analyzing a road sign and a road surface display using the acquired information of the data collection unit and external information acquired from an external device is executed will be described with reference to a flowchart illustrated in FIG. 15.

Hereinafter, processing of each step of the flowchart illustrated in FIG. 15 will be sequentially described.

(Step S521)

In the control unit 120 of the information processing device 100, first, in step S521, the data collection unit 121 collects the sensor detection information acquired by the sensor unit 131.

(Step S522)

Next, in step S522, the control unit 120 of the information processing device 100 acquires the external information from the external device via the communication unit 110.

This processing is executed by the communication unit 110 of the information processing device 100 and the driving assistance processing unit 122 in the control unit 120.

The driving assistance processing unit 122 in the control unit 120 acquires the external information from the external device via the communication unit 110.

Note that, as described above with reference to the flow of FIG. 7, the external device is, for example, another moving apparatus that travels in the vicinity of the host vehicle, such as in front of or behind the host vehicle, the roadside communication unit which is the road infrastructure in the vicinity of the host vehicle, or the external server (driving management server, calculation server, map information provision server, or the like).

The external information acquired from the external device is, for example, image information acquired by a camera provided in another moving apparatus or the roadside communication unit which is the road infrastructure, distance information between the moving apparatus and the dividing line recorded on the road, or the like, which is calculated on the basis of the image information.

As described above, in step S522, the driving assistance processing unit 122 in the control unit 120 acquires the external information from the external device via the communication unit 110.

(Step S523)

Next, in step S523, the driving assistance processing unit 122 in the control unit 120 analyzes the road sign or the road surface display of the road on which the moving apparatus is traveling by using at least one of the sensor detection information of the sensor unit 131 acquired in step S521 or the external information acquired from the external device in step S522.

For example, the road sign or the road surface display of the road on which the moving apparatus is traveling is analyzed using the camera-captured image collected by the data collection unit 121 or the external information acquired from the external device, for example, a camera-captured image of another vehicle or the like.

(Step S524)

Next, in step S524, the determination unit 123 in the control unit 120 determines whether there is a violation of a traffic constraint indicated by the road sign or the road surface display of the road on which the moving apparatus is traveling which is analyzed in step S523.

The traffic constraint indicated by the road sign or the road surface display is, for example, various traffic restrictions indicated by the road sign or the road surface display such as temporary stop, speed restriction, one-way, right turn prohibition, and the like.

In a case where the determination unit 123 determines that there is a violation of the traffic constraint indicated by the road sign or the road surface display, it is determined that the driving accuracy is not good, and the processing of step S525 and subsequent steps is executed.

On the other hand, in a case where it is determined that there is no violation of the traffic constraint indicated by the road sign or the road surface display, it is determined that the driving accuracy is good, and the processing is ended without executing the processing of step S525 and subsequent steps.

Note that, as to whether or not there is a violation of the traffic constraint, notification information from the external device may be used in addition to the configuration in which the determination unit 123 itself in the moving apparatus performs the determination as described above.

For example, information regarding the presence or absence of the violation may be input from the external device such as an external vehicle or infrastructure via the communication unit 110, and determination processing based on the input information may be performed.

(Step S525)

Processing of step S525 and subsequent steps is executed in a case where the violation of the traffic constraint indicated by the road sign or the road surface display is detected in step S524 and it is determined that the driving accuracy is not good.

In this case, in step S525, the driving assistance processing unit 122 in the control unit 120 determines whether or not the moving apparatus is currently executing automated driving.

In a case where the moving apparatus is executing automated driving, the processing proceeds to step S526.

On the other hand, in a case where the moving apparatus is executing manual driving instead of automated driving, the processing proceeds to step S531.

(Step S526)

The processing of step S526 and subsequent steps is the processing executed in a case where the moving apparatus is executing automated driving in step S525.

In a case where the moving apparatus is performing the automated driving, first, in step S526, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.”

Further, the following options are displayed.
Switch automated driving to level 4
Switch automated driving to manual driving

The driver who is the user sees the message displayed on the display unit and selects one of the options.

(Step S527)

In step S527, the driving assistance processing unit 122 in the control unit 120 inputs the user selection information for the downward shift control of the automated driving level displayed on the display unit in step S526 or the switching selection request data to the manual driving, and determines whether or not the selection by the user is the switching to the manual driving.

In a case where the selection by the user is the switching to the manual driving, the processing proceeds to step S528.

On the other hand, in a case where the selection by the user is not the switching to the manual driving but the level downward shift control of the automated driving level, the processing proceeds to step S529.

(Step S528)

In a case where it is determined in step S527 that the selection by the user is the switching to the manual driving, the processing of step S528 is executed.

In this case, in step S528, the driving assistance processing unit 122 in the control unit 120 stops the currently executed automated driving and executes the switching to the manual driving.

(Step S529)

On the other hand, in a case where the selection by the user is not the switching to the manual driving but the level downward shift control of the automated driving level in step S527, the processing of step S529 is executed.

In this case, in step S529, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S523, for example.

For example, processing may be performed such that the downward shift level of the automated driving level is set to 1 level in a case where the difference is small, and the downward shift level of the automated driving level is set to 2 to 3 level in a case where the difference is large.

Here, as the difference between the observation information and the external information compared in step S523, in a case where highly important sign information or traffic constraint information, for example, sign information such as one-way, closed, right turn prohibited, or left turn prohibited, is not included in either the observation information or the external information, it may be determined that the difference is large, and in a case where the less important sign information or traffic constraint information is not included in either the observation information or the external information, it may be determined that the difference is small. That is, different importance levels are assigned to the sign information and the traffic constraint information.

(Step S531)

The processing of step S531 is the processing performed in a case where the moving apparatus is currently executing manual driving instead of automated driving in step S525.

In this case, the driving assistance processing unit 122 in the control unit 120 performs the warning information notification processing in step S531.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 4-6. (Processing Example 6) Driving Control Processing Example According to Distance Calculation Result Between Moving Apparatus and Stop Line Based on Acquired Information of Data Collection Unit

Next, as (Processing Example 6), a driving control processing example according to a distance calculation result between the moving apparatus and the stop line based on the acquired information of the data collection unit will be described.

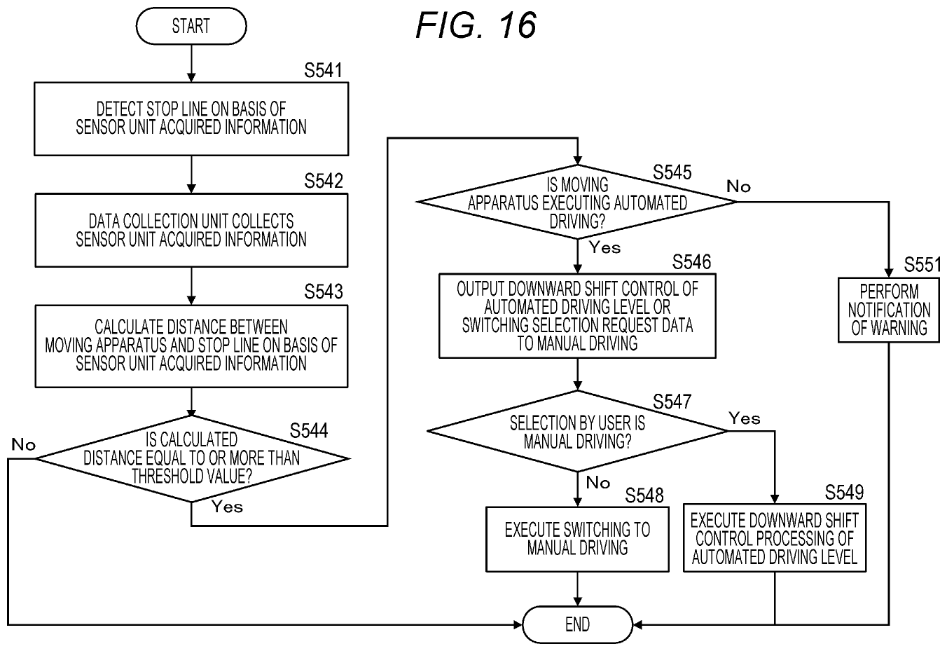

A sequence of processing executed by the information processing device 100 of the present disclosure, that is, the information processing device 100 attached to the moving apparatus 11 in a case where the driving control processing according to the distance calculation result between the moving apparatus and the stop line based on the acquired information of the data collection unit is executed will be described with reference to a flowchart illustrated in FIG. 16.

Hereinafter, processing of each step of the flowchart illustrated in FIG. 16 will be sequentially described.

(Step S541)

First, in step S541, the information processing device 100 executes acquisition processing of the sensor detection information by the sensor unit 131.

For example, the camera-captured image, object distance information, and the like are acquired.

(Step S542)

Next, in step S542, the data collection unit 121 of the control unit 120 collects the sensor detection information acquired by the sensor unit 131.

(Step S543)

Next, in step S543, the driving assistance processing unit 122 in the control unit 120 calculates the distance between the moving apparatus and the stop line using the sensor detection information of the sensor unit 131 acquired by the data collection unit 121 in step S542.

For example, the distance between the stop line of the road on which the moving apparatus is traveling and the moving apparatus is calculated using the camera-captured image collected by the data collection unit 121.

(Step S544)

Next, in step S544, the determination unit 123 in the control unit 120 determines whether or not the distance between the stop line and the moving apparatus calculated in step S543 is equal to or more than a predetermined threshold value.

In a case where the distance between the moving apparatus and the stop line is equal to or more than the predetermined threshold value, it is determined that the driving accuracy is not good, and the processing of step S545 and subsequent steps is executed.

On the other hand, in a case where the distance between the moving apparatus and the stop line is not equal to or more than the predetermined threshold value, it is determined that the driving accuracy is good, and the processing is ended without executing the processing of step S545 and subsequent steps.

(Step S545)

The processing of step S545 and subsequent steps is executed in a case where it is determined in step S544 that the distance between the moving apparatus and the stop line is equal to or more than the predetermined threshold value and the driving accuracy is not good.

In this case, in step S545, the driving assistance processing unit 122 in the control unit 120 determines whether or not the moving apparatus is currently executing automated driving.

In a case where the moving apparatus is executing automated driving, the processing proceeds to step S546.

On the other hand, in a case where the moving apparatus is executing manual driving instead of automated driving, the processing proceeds to step S551.

(Step S546)

The processing of step S546 and subsequent steps is the processing executed in a case where the moving apparatus is executing automated driving in step S545.

In a case where the moving apparatus is performing the automated driving, first, in step S546, the driving assistance processing unit 122 in the control unit 120 outputs the downward shift control of the automated driving level or the switching selection request data to the manual driving.

For example, the downward shift control of the automated driving level or the switching selection request data to the manual driving is output to the display unit of the moving apparatus.

The output data is the display data as described above with reference to FIG. 8.

That is, as illustrated in FIG. 8, the downward shift control of the automated driving level or the switching selection request data to the manual driving is output to the display unit that can be observed by the driver (operator) of the moving apparatus.

The display information example illustrated in FIG. 8 is an example in which the following message is displayed.

“Currently, automated driving at level 5 is being executed. Please select one of the following options.” Further, the following options are displayed.
Switch automated driving to level 4
Switch automated driving to manual driving

The driver who is the user sees the message displayed on the display unit and selects one of the options.

(Step S547)

In step S547, the driving assistance processing unit 122 in the control unit 120 inputs the user selection information for the downward shift control of the automated driving level displayed on the display unit in step S546 or the switching selection request data to the manual driving, and determines whether or not the selection by the user is the switching to the manual driving.

In a case where the selection by the user is the switching to the manual driving, the processing proceeds to step S548.

On the other hand, in a case where the selection by the user is not the switching to the manual driving but the level downward shift control of the automated driving level, the processing proceeds to step S549.

(Step S548)

In a case where it is determined in step S547 that the selection by the user is the switching to the manual driving, the processing of step S548 is executed.

In this case, in step S548, the driving assistance processing unit 122 in the control unit 120 stops the currently executed automated driving and executes the switching to the manual driving.

(Step S549)

On the other hand, in a case where the selection by the user is not the switching to the manual driving but the level downward shift control of the automated driving level in step S547, the processing of step S549 is executed.

In this case, in step S549, the driving assistance processing unit 122 in the control unit 120 executes processing for performing the downward shift control of the level of the automated driving currently being executed.

In a case where the level of the automated driving currently being executed is level 5, the processing of switching to the automated driving of level 4 or the like is executed.

Note that, as described above, the downward shift level of the automated driving level may be set to be changed according to the difference between the observation information and the external information compared in step S543, for example.

For example, processing may be performed such that the downward shift level of the automated driving level is set to 1 level in a case where the difference is small, and the downward shift level of the automated driving level is set to 2 to 3 level in a case where the difference is large.

(Step S551)

The processing of step S551 is the processing performed in a case where the moving apparatus is currently executing manual driving instead of automated driving in step S545.

In this case, the driving assistance processing unit 122 in the control unit 120 performs the warning information notification processing in step S551.

For example, the warning information as described above with reference to FIG. 10 is displayed on the display unit of the moving apparatus.

The driver, who is the user, recognizes that there is a possibility that an abnormality has occurred in the automated driving control system by looking at the message displayed on the display unit, and can perform processing such as stopping the shift to the automated driving or performing the low-level automated driving and paying close attention during the automated driving.

### 5. Hardware Configuration Example of Information Processing Device of Present Disclosure

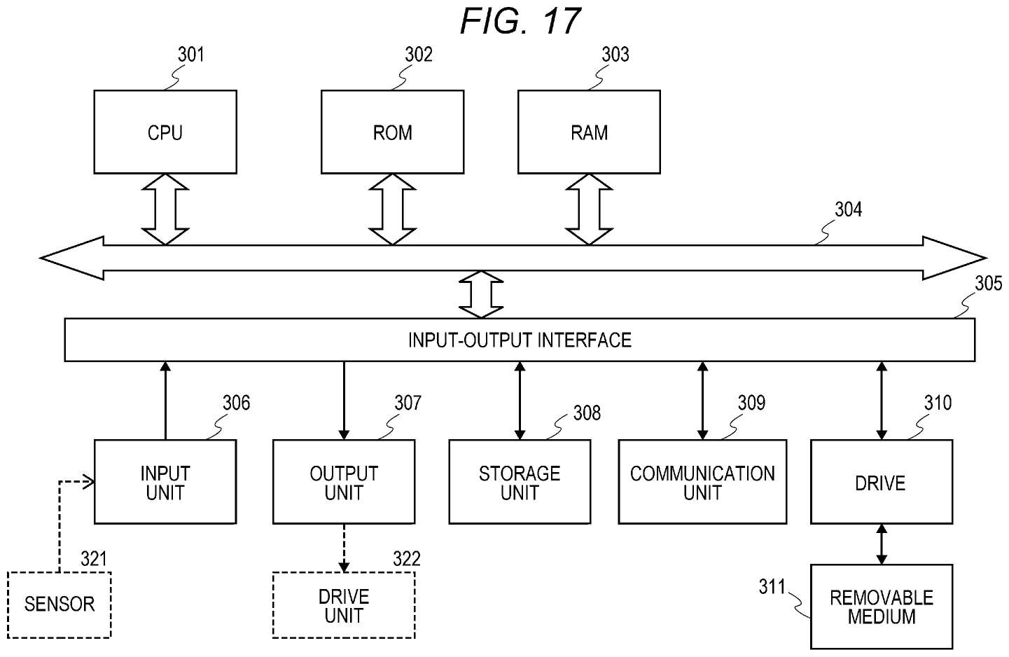

Next, a specific hardware configuration example of the information processing device of the present disclosure will be described with reference to FIG. 17.

FIG. 17 is a diagram illustrating an example of a hardware configuration of the information processing device 100 of the present disclosure described above with reference to FIG. 5.

Hereinafter, each component of the hardware configuration illustrated in FIG. 17 will be described.

A central processing unit (CPU) 301 functions as a data processing unit that executes various processes according to a program stored in a read only memory (ROM) 302 or a storage unit 308. For example, processes according to the sequence described in the above-described embodiment are executed. A random access memory (RAM) 303 stores programs, data, and the like to be executed by the CPU 301. The CPU 301, the ROM 302, and the RAM 303 are connected to each other by a bus 304.

The CPU 301 is connected to an input-output interface 305 via the bus 304, and to the input-output interface 305, an input unit 306 that includes various switches, a keyboard, a touch panel, a mouse, a microphone, a status data acquisition unit such as a sensor, a camera, a GPS, and the like, and an output unit 307 that includes a display, a speaker, and the like are connected.

Note that input information from a sensor 321 is also input to the input unit 306.

Furthermore, the output unit 307 also outputs drive information for a drive unit 322 of the moving apparatus.

The CPU 301 inputs a command, status data, and the like input from the input unit 306, executes various processes, and outputs a processing result to the output unit 307, for example.

The storage unit 308 connected to the input-output interface 305 includes, for example, a hard disk, and the like and stores programs executed by the CPU 301 and various data. A communication unit 309 functions as a data communication transmitting-receiving unit via a network such as the Internet or a local area network, and communicates with an external device.

In addition, a graphics processing unit (GPU) may be provided in addition to or instead of the CPU. For example, the GPU processes image information input from the camera. That is, the CPU or the GPU can be selectively used according to the input information to be handled and the data processing executed according to the program.

A drive 310 connected to the input-output interface 305 drives a removable medium 311 such as a magnetic disk, an optical disk, a magneto-optical disk, or a semiconductor memory such as a memory card, and executes recording or reading of data.

### 6. Summary of Configuration of Present Disclosure

As described above, the embodiment of the present disclosure has been described in detail with reference to a particular embodiment. However, it is obvious that those skilled in the art can make modifications and substitutions of the embodiment without departing from the gist of the present disclosure. In other words, the present invention has been disclosed in the form of exemplification, and should not be interpreted in a limited manner. In order to determine the gist of the present disclosure, the claims should be taken into consideration.

Note that the technology disclosed in the present description can take the following configurations.

(1)

An information processing device, including:
a data collection unit that acquires observation information of a travel environment of a moving apparatus;
a driving assistance processing unit that generates control information based on data collected by the data collection unit and performs driving control; and
a determination unit that compares the observation information acquired by the data collection unit with external information acquired from an external device via a communication unit and determines a matching degree, in which
in a case where the determination unit determines that a matching degree between the observation information and the external information is low, the driving assistance processing unit outputs a downward shift control request of an automated driving level or a shift request to manual driving.

(2)

The information processing device according to (1), in which
the driving assistance processing unit
executes downward shift control processing of the automated driving level or shift processing to the manual driving on the basis of a response from a user to the downward shift control request of the automated driving level or the shift request to the manual driving.

(3)

The information processing device according to (1) or (2), in which
the determination unit
calculates a difference between the observation information and the external information, and
determines, in a case where the calculated difference is equal to or more than a predetermined threshold value, that the matching degree between the observation information and the external information is low.

(4)

The information processing device according to any one of (1) to (3), in which
the external device
is any one of another moving apparatus other than the moving apparatus, a roadside communication unit installed on a road on which the moving apparatus is traveling, or an external server.

(5)

The information processing device according to any one of (1) to (4), in which
the data collection unit
acquires, as the observation information, distance information between the moving apparatus and a dividing line on a road as first distance information,
the determination unit
compares the first distance information acquired by the data collection unit with second distance information as the external information acquired from the external device via the communication unit, and
determines that a matching degree between the observation information and the external information is low in a case where a difference between the first distance information and the second distance information is equal to or more than a predetermined threshold value, and
the driving assistance processing unit
outputs the downward shift control request of the automated driving level or the shift request to the manual driving in response to determination by the determination unit that the matching degree is low.

(6)

The information processing device according to any one of (1) to (5), in which
the data collection unit
acquires traveling road information observable from the moving apparatus as the observation information, and
the determination unit
compares the traveling road information acquired by the data collection unit with map information acquired from the external device via the communication unit, and
determines whether or not the traveling road information matches the map information, and determines that a matching degree between the observation information and the external information is low in a case where the traveling road information does not match the map information, and
the driving assistance processing unit
outputs the downward shift control request of the automated driving level or the shift request to the manual driving in response to determination by the determination unit that the matching degree is low.

(7)

The information processing device according to (6), in which the traveling road information acquired by the data collection unit is sign information regarding a traveling road.

(8)

The information processing device according to (6) or (7), in which
the map information
is a local dynamic map provided by a map information provision server.

(9)

The information processing device according to any one of (6) to (8), in which
the determination unit
performs comparison processing between the traveling road information acquired by the data collection unit and latest updated map information acquired from the external device via the communication unit.

(10)

The information processing device according to any one of (1) to (9), in which
the data collection unit
acquires, as the observation information, an inter-vehicle distance between the moving apparatus and another vehicle as a first inter-vehicle distance,
the determination unit
compares a first inter-vehicle distance acquired by the data collection unit with a second inter-vehicle distance as the external information acquired from the external device via the communication unit, and
determines that a matching degree between the observation information and the external information is low in a case where a difference between the first inter-vehicle distance and the second inter-vehicle distance is equal to or more than a predetermined threshold value, and
the driving assistance processing unit
outputs the downward shift control request of the automated driving level or the shift request to the manual driving in response to determination by the determination unit that the matching degree is low.

(11)

The information processing device according to any one of (1) to (10), in which
the determination unit
determines whether or not a distance between the moving apparatus and a dividing line on a road is equal to or more than a predetermined threshold value, the distance being calculated on the basis of at least one of the observation information or the external information acquired from the external device via the communication unit, and
in a case where the determination unit determines that the distance between the moving apparatus and the dividing line on the road is equal to or more than the predetermined threshold value, the driving assistance processing unit outputs the downward shift control request of the automated driving level or the shift request to the manual driving.

(12)

The information processing device according to any one of (1) to (11), in which
the determination unit
determines presence or absence of a violation of a traffic constraint of the moving apparatus on the basis of at least one of the observation information or the external information acquired from the external device via the communication unit, and
in a case where the determination unit determines that there is a violation due to a traffic constraint of the moving apparatus, the driving assistance processing unit outputs the downward shift control request of the automated driving level or the shift request to the manual driving.

(13)

The information processing device according to any one of (1) to (12), in which
the driving assistance processing unit,
in a case where the determination unit determines that a matching degree between the observation information and the external information is low,
checks whether the moving apparatus is performing automated driving or manual driving, and
in a case where the moving apparatus is performing automated driving,
the driving assistance processing unit outputs the downward shift control request of the automated driving level or the shift request to the manual driving.

(14)

The information processing device according to any one of (1) to (13), in which
the driving assistance processing unit,
in a case where the determination unit determines that a matching degree between the observation information and the external information is low,
checks whether the moving apparatus is performing automated driving or manual driving, and
in a case where the moving apparatus is performing manual driving,
the driving assistance processing unit outputs a warning notification indicating occurrence of abnormality.

(15)

An information processing system including a moving apparatus and an external device, in which
the moving apparatus includes
a data collection unit that acquires observation information of a travel environment of the moving apparatus,
a driving assistance processing unit that generates control information based on data collected by the data collection unit and performs driving control, and
a communication unit that communicates with the external device,
the external device
is configured to acquire observation information of a travel environment of the moving apparatus and transmit the acquired observation information to the moving apparatus as external information,
the moving apparatus
includes a determination unit that compares the observation information acquired by the data collection unit with external information acquired from the external device and determines a matching degree, and
in a case where the determination unit determines that a matching degree between the observation information and the external information is low, the driving assistance processing unit outputs a downward shift control request of an automated driving level or a shift request to manual driving.

(16)

The information processing system according to (15), in which
the external device
is any one of another moving apparatus other than the moving apparatus, a roadside communication unit installed on a road on which the moving apparatus is traveling, or an external server.

(17)

The information processing system according to (15) or (16), in which
the driving assistance processing unit of the moving apparatus
executes downward shift control processing of the automated driving level or shift processing to the manual driving on the basis of a response from a user to the downward shift control request of the automated driving level or the shift request to the manual driving.

(18)

An information processing method executed in an information processing device, the information processing method including:
a data collection step in which a data collection unit acquires observation information of a travel environment of a moving apparatus;
a driving assistance processing step in which a driving assistance processing unit generates control information based on data collected by the data collection unit and performs driving control; and
a determination step in which a determination unit compares the observation information acquired by the data collection unit with external information acquired from an external device via a communication unit and determines a matching degree, in which
in a case where the determination unit determines that a matching degree between the observation information and the external information is low, the driving assistance processing unit outputs a downward shift control request of an automated driving level or a shift request to manual driving.

(19)

An information processing method executed in an information processing system including a moving apparatus and an external device, the information processing method including:
a data collection step in which a data collection unit of the moving apparatus acquires observation information of a travel environment of the moving apparatus;
a driving assistance processing step in which the driving assistance processing unit of the moving apparatus generates control information based on data collected by the data collection unit and performs driving control, and
a step in which the external device
acquires observation information of a travel environment of the moving apparatus and transmits the acquired observation information to the moving apparatus as external information;
a determination step in which a determination unit of the moving apparatus compares the observation information acquired by the data collection unit with external information acquired from the external device and determines a matching degree, in which
in a case where, in the determination step, it is determined that a matching degree between the observation information and the external information is low, the driving assistance processing unit of the moving apparatus outputs a downward shift control request of an automated driving level or a shift request to manual driving.

(20)

A program for causing an information processing device to execute information processing causing:
a data collection unit to execute a data collection step of acquiring observation information of a travel environment of a moving apparatus;
a driving assistance processing unit to execute a driving assistance processing step of generating control information based on data collected by the data collection unit and performing driving control; and
a determination unit to execute a determination step of comparing the observation information acquired by the data collection unit with external information acquired from an external device via a communication unit and determining a matching degree, in which
in a case where the determination unit determines that a matching degree between the observation information and the external information is low, the driving assistance processing unit is further caused to output a downward shift control request of an automated driving level or a shift request to manual driving.

Furthermore, a series of processes described in the description can be executed by hardware, software, or a combined configuration of the both. In a case of executing processes by software, a program recording a processing sequence can be installed and run on a memory in a computer incorporated in dedicated hardware, or the program can be installed and run on a general-purpose computer capable of executing various processes. For example, the program can be recorded in advance on a recording medium. In addition to being installed on a computer from a recording medium, the program can be received via a network such as a local area network (LAN) or the Internet and installed on a recording medium such as an internal hard disk.

Note that the various processes described in the description are not only executed in time series according to the description, but may be executed in parallel or individually according to processing capability of the device that executes the processes or as necessary. Furthermore, a system in the present description is a logical set configuration of a plurality of devices, and is not limited to one in which devices with respective configurations are in the same housing.

### INDUSTRIAL APPLICABILITY

As described above, according to a configuration of one embodiment of the present disclosure, it is possible to achieve safe traveling by detecting an abnormality in automated driving early and performing downward shift control of an automated driving level or shifting to manual driving.

Specifically, for example, there are provided a data collection unit that acquires observation information of a travel environment of a moving apparatus such as an automated driving vehicle, a driving assistance processing unit that generates control information based on data collected by the data collection unit and performs driving control, and a determination unit that compares the observation information acquired by the data collection unit with external information acquired from an external device via a communication unit and determines a matching degree. In a case where the determination unit determines that a matching degree between the observation information and the external information is low, the driving assistance processing unit outputs a downward shift control request of an automated driving level or a shift request to manual driving, and executes downward shift control processing of the automated driving level or shift processing to the manual driving on the basis of selection of the user.

With this configuration, it is possible to achieve safe traveling by detecting an abnormality in the automated driving early and performing the downward shift control of the automated driving level or the shifting to the manual driving.

### REFERENCE SIGNS LIST

10 Vehicle traveling unit
11 Moving apparatus
12 Roadside communication unit (RSU)
20 Server
21 Driving management server
22 Calculation server
23 Map information provision server
30 Communication network
31 Base station
50 Information processing system
100 Information processing device
110 Communication unit
111 Reception unit
112 Transmission unit
120 Control unit
121 Data collection unit
122 Driving assistance processing unit
123 Determination unit
124 Communication control unit
131 Sensor unit
132 Storage unit
133 Input-output unit
151 Position information sensor
152 Camera module
153 LiDAR
154 Radar
155 Sensor
301 CPU
302 ROM
303 RAM
304 Bus
305 Input-output interface
306 Input unit
307 Output unit
308 Storage unit
309 Communication unit
310 Drive
311 Removable medium
321 Sensor
322 Drive unit

1. An information processing device, comprising:
a data collection unit that acquires observation information of a travel environment of a moving apparatus;
a driving assistance processing unit that generates control information based on data collected by the data collection unit and performs driving control; and
a determination unit that compares the observation information acquired by the data collection unit with external information acquired from an external device via a communication unit and determines a matching degree, wherein
in a case where the determination unit determines that a matching degree between the observation information and the external information is low, the driving assistance processing unit outputs a downward shift control request of an automated driving level or a shift request to manual driving.

2. The information processing device according to claim 1, wherein
the driving assistance processing unit
executes downward shift control processing of the automated driving level or shift processing to the manual driving on a basis of a response from a user to the downward shift control request of the automated driving level or the shift request to the manual driving.

3. The information processing device according to claim 1, wherein
the determination unit
calculates a difference between the observation information and the external information, and
determines, in a case where the calculated difference is equal to or more than a predetermined threshold value, that the matching degree between the observation information and the external information is low.

4. The information processing device according to claim 1, wherein
the external device
is any one of another moving apparatus other than the moving apparatus, a roadside communication unit installed on a road on which the moving apparatus is traveling, or an external server.

5. The information processing device according to claim 1, wherein
the data collection unit
acquires, as the observation information, distance information between the moving apparatus and a dividing line on a road as first distance information,
the determination unit
compares the first distance information acquired by the data collection unit with second distance information as the external information acquired from the external device via the communication unit, and
determines that a matching degree between the observation information and the external information is low in a case where a difference between the first distance information and the second distance information is equal to or more than a predetermined threshold value, and
the driving assistance processing unit
outputs the downward shift control request of the automated driving level or the shift request to the manual driving in response to determination by the determination unit that the matching degree is low.

6. The information processing device according to claim 1, wherein
the data collection unit
acquires traveling road information observable from the moving apparatus as the observation information, and
the determination unit
compares the traveling road information acquired by the data collection unit with map information acquired from the external device via the communication unit, and
determines whether or not the traveling road information matches the map information, and determines that a matching degree between the observation information and the external information is low in a case where the traveling road information does not match the map information, and
the driving assistance processing unit
outputs the downward shift control request of the automated driving level or the shift request to the manual driving in response to determination by the determination unit that the matching degree is low.

7. The information processing device according to claim 6, wherein the traveling road information acquired by the data collection unit is sign information regarding a traveling road.

8. The information processing device according to claim 6, wherein
the map information
is a local dynamic map provided by a map information provision server.

9. The information processing device according to claim 6, wherein
the determination unit
performs comparison processing between the traveling road information acquired by the data collection unit and latest updated map information acquired from the external device via the communication unit.

10. The information processing device according to claim 1, wherein
the data collection unit
acquires, as the observation information, an inter-vehicle distance between the moving apparatus and another vehicle as a first inter-vehicle distance,
the determination unit
compares a first inter-vehicle distance acquired by the data collection unit with a second inter-vehicle distance as the external information acquired from the external device via the communication unit, and
determines that a matching degree between the observation information and the external information is low in a case where a difference between the first inter-vehicle distance and the second inter-vehicle distance is equal to or more than a predetermined threshold value, and
the driving assistance processing unit
outputs the downward shift control request of the automated driving level or the shift request to the manual driving in response to determination by the determination unit that the matching degree is low.

11. The information processing device according to claim 1, wherein
the determination unit
determines whether or not a distance between the moving apparatus and a dividing line on a road is equal to or more than a predetermined threshold value, the distance being calculated on a basis of at least one of the observation information or the external information acquired from the external device via the communication unit, and
in a case where the determination unit determines that the distance between the moving apparatus and the dividing line on the road is equal to or more than the predetermined threshold value, the driving assistance processing unit outputs the downward shift control request of the automated driving level or the shift request to the manual driving.

12. The information processing device according to the determination unit
determines presence or absence of a violation of a traffic constraint of the moving apparatus on a basis of at least one of the observation information or the external information acquired from the external device via the communication unit, and
in a case where the determination unit determines that there is a violation due to a traffic constraint of the moving apparatus, the driving assistance processing unit outputs the downward shift control request of the automated driving level or the shift request to the manual driving.

13. The information processing device according to claim 1, wherein
the driving assistance processing unit,
in a case where the determination unit determines that a matching degree between the observation information and the external information is low,
checks whether the moving apparatus is performing automated driving or manual driving, and
in a case where the moving apparatus is performing automated driving,
the driving assistance processing unit outputs the downward shift control request of the automated driving level or the shift request to the manual driving.

14. The information processing device according to claim 1, wherein
the driving assistance processing unit,
in a case where the determination unit determines that a matching degree between the observation information and the external information is low,
checks whether the moving apparatus is performing automated driving or manual driving, and
in a case where the moving apparatus is performing manual driving,
the driving assistance processing unit outputs a warning notification indicating occurrence of abnormality.

15. An information processing system comprising a moving apparatus and an external device, wherein
the moving apparatus includes
a data collection unit that acquires observation information of a travel environment of the moving apparatus,
a driving assistance processing unit that generates control information based on data collected by the data collection unit and performs driving control, and
a communication unit that communicates with the external device,
the external device
is configured to acquire observation information of a travel environment of the moving apparatus and transmit the acquired observation information to the moving apparatus as external information,
the moving apparatus
includes a determination unit that compares the observation information acquired by the data collection unit with external information acquired from the external device and determines a matching degree, and
in a case where the determination unit determines that a matching degree between the observation information and the external information is low, the driving assistance processing unit outputs a downward shift control request of an automated driving level or a shift request to manual driving.

16. The information processing system according to claim 15, wherein
the external device
is any one of another moving apparatus other than the moving apparatus, a roadside communication unit installed on a road on which the moving apparatus is traveling, or an external server.

17. The information processing system according to claim 15, wherein
the driving assistance processing unit of the moving apparatus
executes downward shift control processing of the automated driving level or shift processing to the manual driving on a basis of a response from a user to the downward shift control request of the automated driving level or the shift request to the manual driving.

18. An information processing method executed in an information processing device, the information processing method comprising:
a data collection step in which a data collection unit acquires observation information of a travel environment of a moving apparatus;
a driving assistance processing step in which a driving assistance processing unit generates control information based on data collected by the data collection unit and performs driving control; and
a determination step in which a determination unit compares the observation information acquired by the data collection unit with external information acquired from an external device via a communication unit and determines a matching degree, wherein
in a case where the determination unit determines that a matching degree between the observation information and the external information is low, the driving assistance processing unit outputs a downward shift control request of an automated driving level or a shift request to manual driving.

19. An information processing method executed in an information processing system including a moving apparatus and an external device, the information processing method comprising:
a data collection step in which a data collection unit of the moving apparatus acquires observation information of a travel environment of the moving apparatus;
a driving assistance processing step in which the driving assistance processing unit of the moving apparatus generates control information based on data collected by the data collection unit and performs driving control, and
a step in which the external device
acquires observation information of a travel environment of the moving apparatus and transmits the acquired observation information to the moving apparatus as external information;
a determination step in which a determination unit of the moving apparatus compares the observation information acquired by the data collection unit with external information acquired from the external device and determines a matching degree, wherein
in a case where, in the determination step, it is determined that a matching degree between the observation information and the external information is low, the driving assistance processing unit of the moving apparatus outputs a downward shift control request of an automated driving level or a shift request to manual driving.

20. A program for causing an information processing device to execute information processing causing:
a data collection unit to execute a data collection step of acquiring observation information of a travel environment of a moving apparatus;
a driving assistance processing unit to execute a driving assistance processing step of generating control information based on data collected by the data collection unit and performing driving control; and
a determination unit to execute a determination step of comparing the observation information acquired by the data collection unit with external information acquired from an external device via a communication unit and determining a matching degree, wherein
in a case where the determination unit determines that a matching degree between the observation information and the external information is low, the driving assistance processing unit is further caused to output a downward shift control request of an automated driving level or a shift request to manual driving.
